(19) United States
(12) Patent Application Publication
(10) Pub. No.: US 2026/0051940 A1
(43) Pub. Date: Feb. 19, 2026

(54) COMBINATORIAL BASED BEAM INDEX REPORT AND REQUEST FOR BEAM PREDICTIONS

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Tao LUO, San Diego, CA (US)

(21) Appl. No.: 19/101,172

(22) PCT Filed: Sep. 30, 2022
(86) PCT No.: PCT/CN2022/123270

§ 371 Date: Feb. 4, 2025

(51) Int. Cl. H04B 7/06

(52) U.S. Cl. CPC H04B 7/06952

(57) ABSTRACT

An apparatus configured to transmit a first indication of an index associated with a first set of spatial-domain resources in a plurality of spatial-domain resources and transmit or receive channel state information indicative of at least one characteristic of each spatial-domain resource in the first set of spatial-domain resources. In some aspects, an apparatus configured to receive a first indication of an index associated with a first set of spatial-domain resources in a plurality of spatial-domain resources and receive or transmit channel state information indicative of at least one characteristic of each spatial-domain resource in the first set of spatial-domain resources.

### TECHNICAL FIELD

The present disclosure relates generally to communication systems, and more particularly, to identifying a set of resources associated with a measurement operation.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be configured to transmit a first indication of an index associated with a first set of spatial-domain resources in a plurality of spatial-domain resources and transmit information indicative of at least one characteristic of each spatial-domain resource in the first set of spatial-domain resources.

In an aspect of the disclosure, a method, a computer-readable medium, and an apparatus are provided. The apparatus may be configured to receive a first indication of an index associated with a first set of spatial-domain resources in a plurality of spatial-domain resources and receive information indicative of at least one characteristic of each spatial-domain resource in the first set of spatial-domain resources.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A illustrates a first set of Tx resources associated with, or for, transmission from a transmitting device and a set of Rx resources associated with, or for, reception at a receiving device in accordance with some aspects of the disclosure.

FIG. 4B illustrates a second set of Tx resources associated with, or for, transmission from the transmitting device and the set of Rx resources associated with, or for, reception at the receiving device in accordance with some aspects of the disclosure.

FIG. 4C illustrates a set of beam pairs (e.g., Tx resource-Rx resource pairs) that may be used for a CSI measurement and/or reporting in accordance with some aspects of the disclosure.

FIG. 5 illustrates a set of possible ordering algorithms for the known, or configured, ordering of resources using the example of the Tx resources and Tx and Rx resource pairs of FIG. 4C.

FIG. 6 is a diagram illustrating a selection of resources from a set of resources and a set of methods of indicating the selected resources in accordance with some aspects of the disclosure.

FIG. 7 is a call flow diagram illustrating a set of communications between a UE and a base station based on a bitmap-based index and/or a combinatorial-based index in accordance with some aspects of the disclosure.

FIG. 8 is a flowchart of a method of wireless communication.

FIG. 9 is a flowchart of a method of wireless communication.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a flowchart of a method of wireless communication.

FIG. 15 is a flowchart of a method of wireless communication.

FIG. 16 is a flowchart of a method of wireless communication.

FIG. 17 is a diagram illustrating an example of a hardware implementation for an apparatus.

FIG. 18 is a diagram illustrating an example of a hardware implementation for a network entity.

### DETAILED DESCRIPTION

In some aspects of wireless communication, e.g., 5G NR, one or more beam management operations are performed to measure and/or predict channel quality, e.g., for a CSI report. The CSI report, in some aspects, includes an identification of a set of beams (e.g., spatial domain resources and/or temporal domain resources) associated with beamforming a set of transmissions (e.g., RS transmissions during a measuring operation and subsequent data transmissions) from a transmitting device. The identified beams may include beams associated with a measurement and/or prediction by the reporting device. Although currently a number of beams selected for measurement and/or reporting, in some aspects, may be small (e.g., 1, 2, or 4), the selection of larger numbers of beams selected for measurement and/or reporting may be used in future implementations. For reports associated with a large number (e.g., 8 or more) of measured and/or predicted beams selected from an even larger number of candidate beams for measurement and/or prediction (e.g., 16 or more), identifying the measured and/or predicted beams may consume a large number of signaling resources (e.g., may introduce a large overhead). Accordingly, a method and apparatus are provided to reduce an overhead associated with identifying a set of beams (e.g., CSI resources) for measurement and/or reporting compared to a naïve extension of a current method and apparatus sending a list of beam identifiers (IDs), such as CSI measurement resource (CMR) IDs, interference measurement resource (IMR) IDs, or SSB resource indicators (SSBRIs).

The method and apparatus may use a combinatorial index and/or a bitmap (sometimes referred to as a combinatorial-based index or a bitmap-based index, respectively) to signal and/or identify a set of beams for measurement and/or reporting. The combinatorial index and/or the bitmap may, in some aspects, to a known, or configured, ordering of candidate beams and or beam pairs (e.g., combinations of a first resource or beam for transmitting a signal from the transmitting device and a second resource or beam for receiving the signal at a receiving device) provided by the method and apparatus.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution. Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

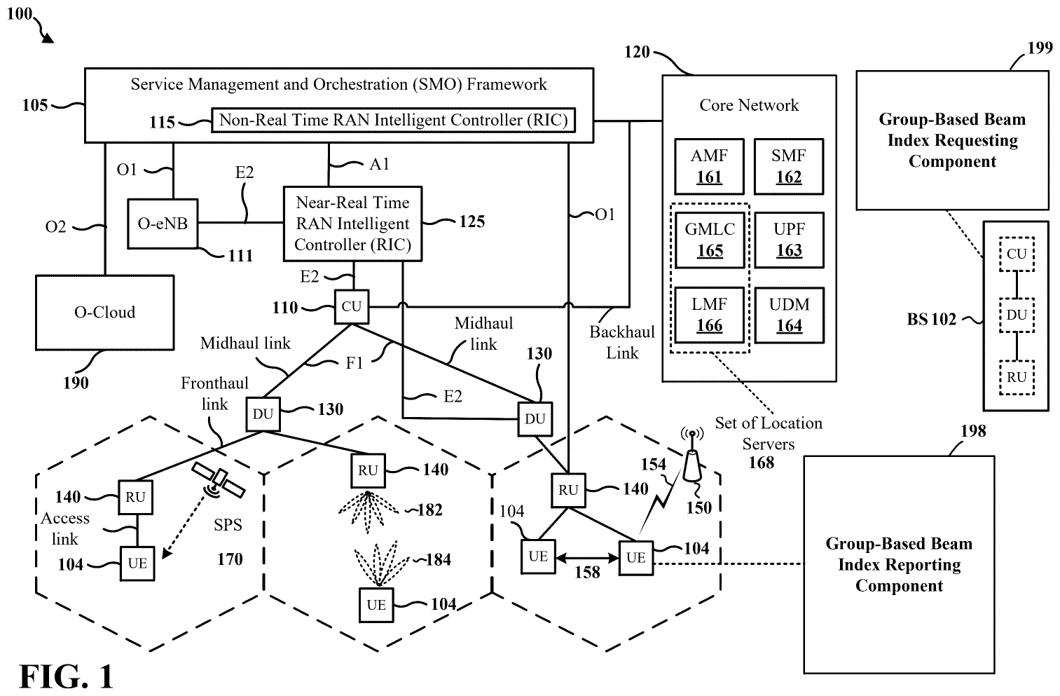

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a group-based beam index (GBBI) reporting component 198 configured to transmit a first indication of an index associated with a first set of spatial-domain resources in a plurality of spatial-domain resources and transmit information indicative of at least one characteristic of each spatial-domain resource in the first set of spatial-domain resources. In certain aspects, the UE 104 may include a GBBI reporting component 198 configured to receive a first indication of an index associated with a first set of spatial-domain resources in a plurality of spatial-domain resources and receive a first indication of an index associated with a first set of spatial-domain resources in a plurality of spatial-domain resources. In certain aspects, the base station 102 may include a GBBI requesting component 199 configured to transmit a first indication of an index associated with a first set of spatial-domain resources in a plurality of spatial-domain resources and transmit information indicative of at least one characteristic of each spatial-domain resource in the first set of spatial-domain resources. In certain aspects, the base station 102 may include a GBBI requesting component 199 configured to receive a first indication of an index associated with a first set of spatial-domain resources in a plurality of spatial-domain resources and receive a first indication of an index associated with a first set of spatial-domain resources in a plurality of spatial-domain resources. Although the following description may be focused on 5G NR, the concepts described herein may be applicable to other similar areas, such as LTE, LTE-A, CDMA, GSM, and other wireless technologies.

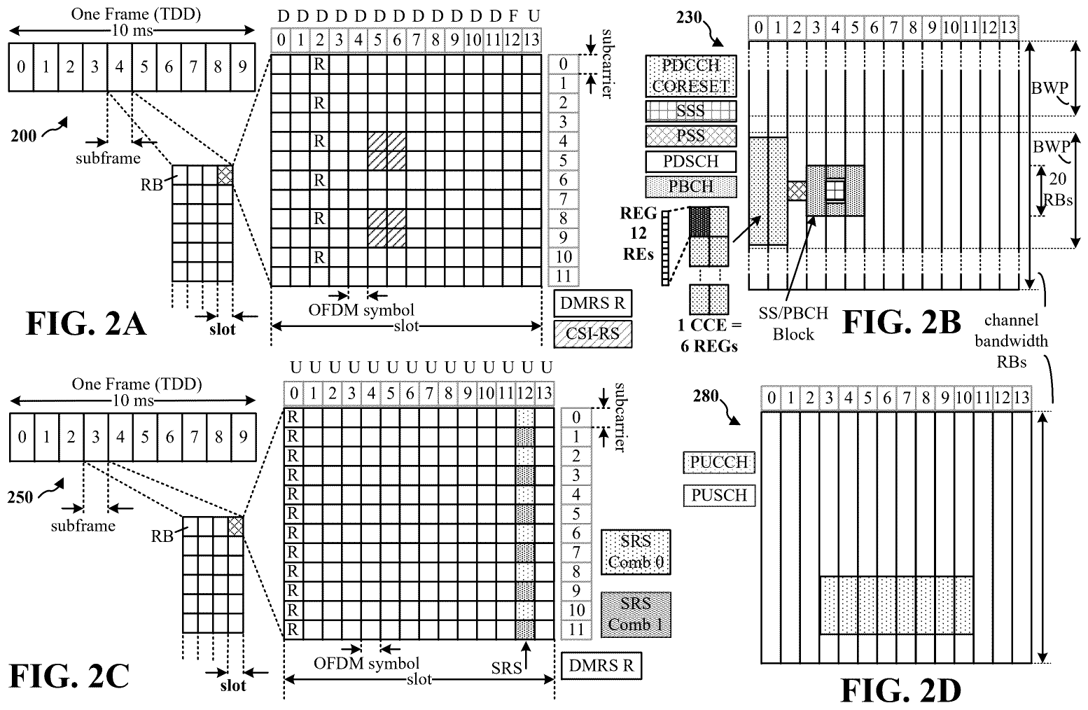

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}* 15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

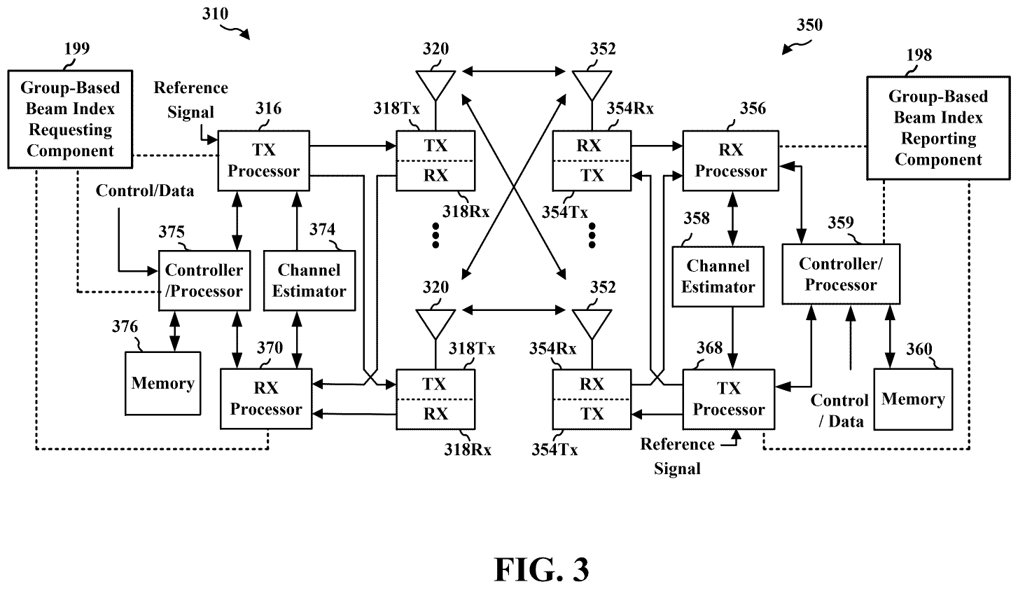

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the GBBI reporting component 198 of FIG. 1.

At least one of the TX processor 316, the RX processor 370, and the controller/processor 375 may be configured to perform aspects in connection with the GBBI requesting component 199 of FIG. 1.

In some aspects of wireless communication, e.g., 5G NR, one or more beam management operations are performed to measure and/or predict channel quality, e.g., for a CSI report. The CSI report, in some aspects, includes an identification of a set of beams (e.g., spatial domain resources and/or temporal domain resources) associated with beamforming a set of transmissions (e.g., RS transmissions during a measuring operation and subsequent data transmissions) from a transmitting device. The identified beams may include beams associated with a measurement and/or prediction by the reporting device. Although currently a number of beams selected for measurement and/or reporting, in some aspects, may be small (e.g., 1, 2, or 4), the selection of larger numbers of beams selected for measurement and/or reporting may be used in future implementations. For reports associated with a large number (e.g., 8 or more) of measured and/or predicted beams selected from an even larger number of candidate beams for measurement and/or prediction (e.g., 16 or more), identifying the measured and/or predicted beams may consume a large number of signaling resources (e.g., may introduce a large overhead). Accordingly, a method and apparatus are provided to reduce an overhead associated with identifying a set of beams (e.g., CSI resources) for measurement and/or reporting compared to a naïve extension of a current method and apparatus sending a list of beam IDs such as CMR IDs, IMR IDS, or SSBRI. The method and apparatus may use a combinatorial index and/or a bitmap (sometimes referred to as a combinatorial-based index or a bitmap-based index, respectively) to signal and/or identify a set of beams for measurement and/or reporting. The combinatorial index and/or the bitmap may, in some aspects, to a known, or configured, ordering of candidate beams and or beam pairs (e.g., combinations of a first resource or beam for transmitting a signal from the transmitting device and a second resource or beam for receiving the signal at a receiving device) provided by the method and apparatus.

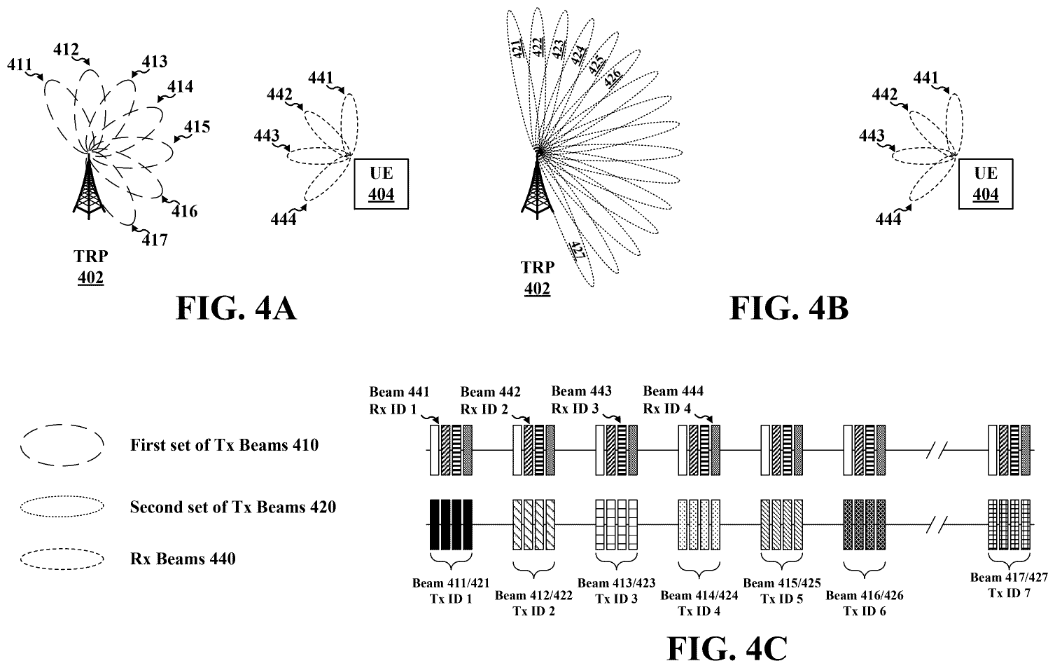

FIG. 4A illustrates a first set of Tx resources 410 (e.g., spatial-domain resources or beams) associated with, or for, transmission from a transmitting device, base station 402 and a set of Rx resources 440 (e.g., spatial-domain resources or beams) associated with, or for, reception at a receiving device, UE 404, in accordance with some aspects of the disclosure. The base station 402, in some aspects, may be any of a base station, a network node, a network entity, or any wireless device capable of beamforming. The first set of Tx resources 410 may include multiple resources and/or beams including beam 411, beam 412, beam 413, beam 414, beam 415, beam 416, and beam 417 that cover a range of angles and/or directions around the base station 402. The first set of Tx resources 410, in some aspects, may include additional beams and/or resources to provide beams covering angles and/or directions in addition to those illustrated. The set of Rx resources 440 may similarly provide beams (e.g., beam 441, beam 442, beam 443, and beam 444) covering a range of angles and/or directions around the UE 404 and, in some aspects, may include additional beams and/or resources to provide beams covering angles and/or directions in addition to those illustrated. In some aspects, each resource in each set of resources may be associated with a resource ID (e.g., a CMR ID, an IMR ID, an SSBRI, a UE Rx-beam ID, or other identifier). The size (e.g., in bits) of different IDs may be based on the number of possible and/or candidate resources. For example, for identifying a particular resource in a set of 32 resources an ID may include at least 5 bits (e.g., a number of bits able to represent 32 unique values), whereas for identifying a particular resource in a set of 8 resources an ID may include as little as 3 bits. Generally, for a set of K resources, a number of bits equal to [Log₂K] may be used to identify a particular resource. Accordingly, to identify a small number of Tx resources, such as 1, 2, or 4 Tx resources in a set of 16 Tx resources may use 4 bits, 8 bits, or 16 bits, respectively. Similarly, identifying 1, 2, or 4, Tx resources from a set of 32 Tx resources may use 5 bits, 10 bits, or 20 bits, respectively. However, to identify a large number of Tx resources, such as 16 Tx resources from a set of 32 Tx resources may use 80 bits (e.g., 5 bits for each of the 16 Tx resources).

FIG. 4B illustrates a second set of Tx resources 420 (e.g., spatial-domain resources or beams) associated with, or for, transmission from the transmitting device, base station 402 and the set of Rx resources 440 (e.g., spatial-domain resources or beams) associated with, or for, reception at the receiving device, UE 404, in accordance with some aspects of the disclosure. The second set of Tx resources 420 may include multiple resources and/or beams including beam 421, beam 422, beam 423, beam 424, beam 425, beam 426, and beam 427 that cover a range of angles and/or directions around the base station 402. The second set of Tx resources 420, in some aspects, may include additional beams and/or resources to provide beams covering angles and/or directions in addition to those illustrated. As illustrated, a width of a beam and/or an angular difference (e.g., granularity) between adjacent beams and/or resources may be different for different sets of Tx resources.

FIG. 4C illustrates a set of beam pairs (e.g., Tx resource-Rx resource pairs) that may be used for a CSI measurement and/or reporting in accordance with some aspects of the disclosure. The number of possible beam pairs for a set of Tx resources and a set of Rx resources, in some aspects, may simply be the number of Tx resources in the set of Tx resources multiplied by a number of Rx resources in the set of Rx resources. While the set of beam pairs illustrated in FIG. 4C is based on the beams illustrated in FIGS. 4A and 4B, additional beam pairs may be possible. For example, referring to FIGS. 4A and 4B, assuming that the first set of Tx resources 410 includes 16 resources (beams), or that the second set of Tx resources 420 includes 32 resources, and that the set of Rx resources 440 includes 8 resources, the total number of beam pairs, in some aspects, may be 128 or 256 in the example illustrated in FIGS. 4A and 4B, respectively. In such aspects, the beam pairs may be identified by using the identifier of the Tx resource and the identifier of the Rx resource. Using both the Tx resource ID and the Rx resource ID increases the signaling overhead associated with identifying a set of beam pairs (especially a set of a large number of beam pairs).

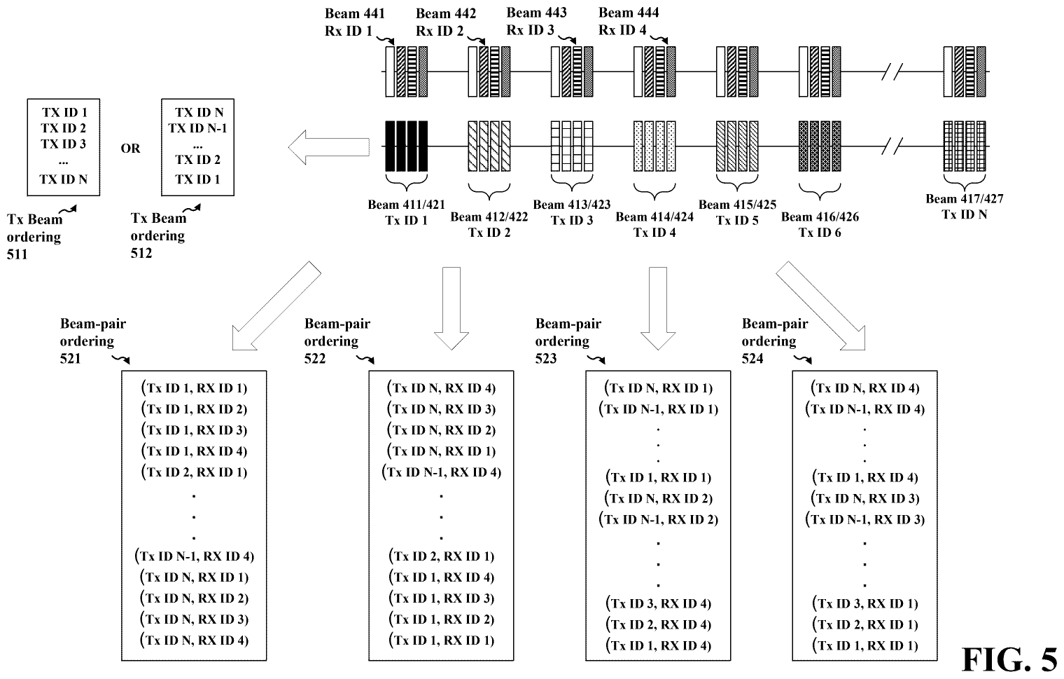

In some aspects, an ordering of resources (either Tx resources or pairs of Tx and Rx resources) may be known (e.g., preconfigured) or configured for a CSI measurement and/or reporting operation. FIG. 5 illustrates a set of possible ordering algorithms for the known, or configured, ordering of resources using the example of the Tx resources and Tx and Rx resource pairs (e.g., beam pairs) of FIG. 4C. For example, for a set of Tx resources a first known, or configured, Tx resource (beam) ordering 511 may be based on an ascending order of Tx resource IDs (e.g., CMR IDs, IMR IDs, SSBRIS, or other unique identifier of the Tx resource). Alternatively, a second known, or configured, Tx resource (beam) ordering 512 may be based on a descending order of Tx resource IDs (e.g., CMR IDs, IMR IDs, SSBRIs, or other unique identifier of the Tx resource).

For Tx and Rx resource pairs may similarly be order based on resource IDs. For example, a first beam-pair ordering 521 may be based on an ascending order of Tx resource IDs and then on an ascending order of Rx resource IDs (e.g., UE Rx resource IDs). In some aspects, this may be equivalent to an ascending order of a value generated by concatenating the Tx resource ID and the Rx resource ID. Similarly, a second beam-pair ordering 522, may be based on a descending order of Tx resource IDs and then on a descending order of Rx resource IDs (e.g., UE Rx resource IDs). In some aspects, this may be equivalent to a descending order of a value generated by concatenating the Tx resource ID and the Rx resource ID. Alternatively, a third beam-pair ordering 523 may be based first on an ascending order of Rx resource IDs and then on a descending order of Tx resource IDs and a fourth beam-pair ordering 524 may be based first on a descending order of Rx resource IDs and then on a descending order of Tx resource IDs. In some aspects, this may be equivalent to a descending order of a value generated by concatenating the Rx resource ID and the Tx resource ID. Using the known, or configured, ordering of Tx resources and/or Tx and Rx resource pairs, an index into the ordered list may be used to identify a particular resource, or resource pair, from any set of identified resources.

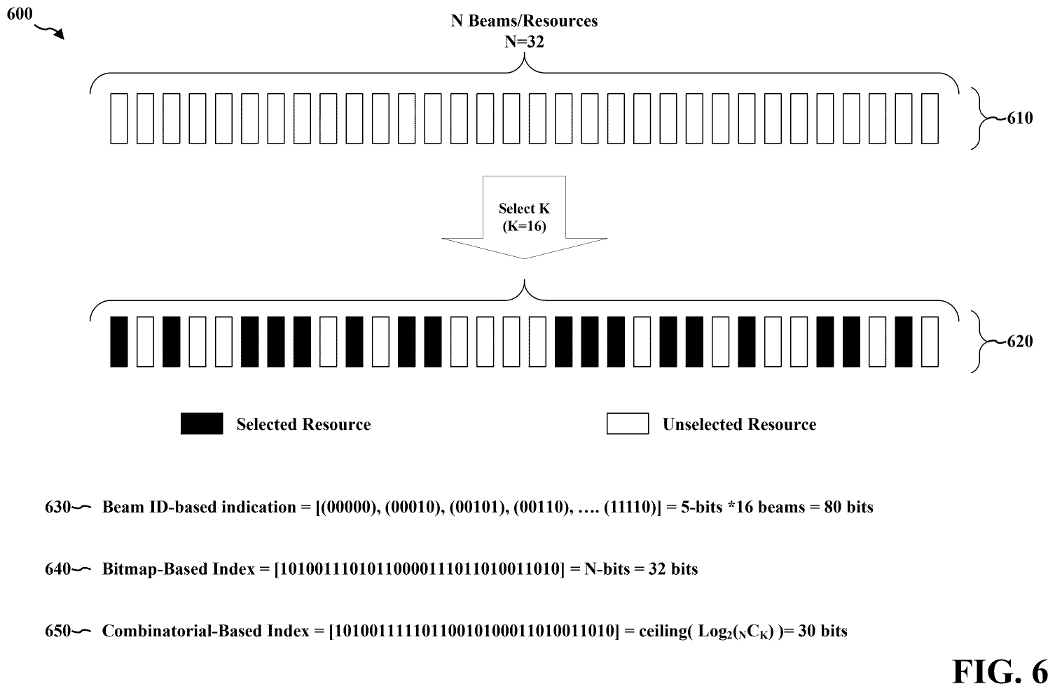

FIG. 6 is a diagram 600 illustrating a selection of K resources 620 from a set of N resources 610 and a set of methods of indicating the selected resources in accordance with some aspects of the disclosure. The set of methods, in some aspects, may include a beam ID-based method 630, a bitmap-based method 640, and/or a combinatorial based method 650. In some aspects, the set of N resources is a set of resources identified in an associated CSI report setting (e.g., via RRC signaling). The set of N resources 610, may be ordered according to a known, or configured, beam (or beam-pair) ordering (e.g., one of the Tx resource orderings 511 or 512 or one of the beam-pair orderings 521-524 illustrated in FIG. 5). For the beam ID-based method 630, the selection (or indication) of the K resources 620 may be independent of the known, or configured order and may instead be based on a set of resource IDs (e.g., Tx resource IDs or Tx resource IDs and Rx resource IDs associated with a resource pair). For example, if each Tx resource has a 5-bit ID (e.g., for a set of 32 candidate resources), the K resources may be indicated by a set of K 5-bit IDs.

In some aspect, the selection (or indication) of the K resources 620, e.g., using the bitmap-based method 640, and/or the combinatorial based method 650, may be based on a position of the K resources in the ordered set of N resources. For example, the bitmap associated with the bitmap-based method 640 may include a set of bits with each bit corresponding to a corresponding element of the ordered list with a selected element being indicated with one of a “0” or “1” value (with the other value indicating not being selected). For the combinatorial based method 650, the set of bits indicating the selected K resources 620 may correspond to a particular combination of positions (e.g., positions 1, 3, 6, 7, 8, 10, 12, 13, 18, 19, 20, 22, 23, 25, 28, 29, and 31) from the ordered list. The mapping from the sequence of bits used to indicate the selected K resources 620 to the particular combination of bits may be based on a known, or configured, mapping or algorithm.

As illustrated in FIG. 6, the bitmap-based method 640, and/or the combinatorial based method 650, in some aspects, may use fewer bits to indicate the set of K resources 620 than using the beam ID-based method 630. However, in some aspects, the beam ID-based method 630 may use fewer bits than the bitmap-based method 640, and/or the combinatorial based method 650. For example, if a small number of beams (e.g., 1, 2, or 4) is to be selected and/or indicated the number of bits may be less than the bitmap-based method 640.

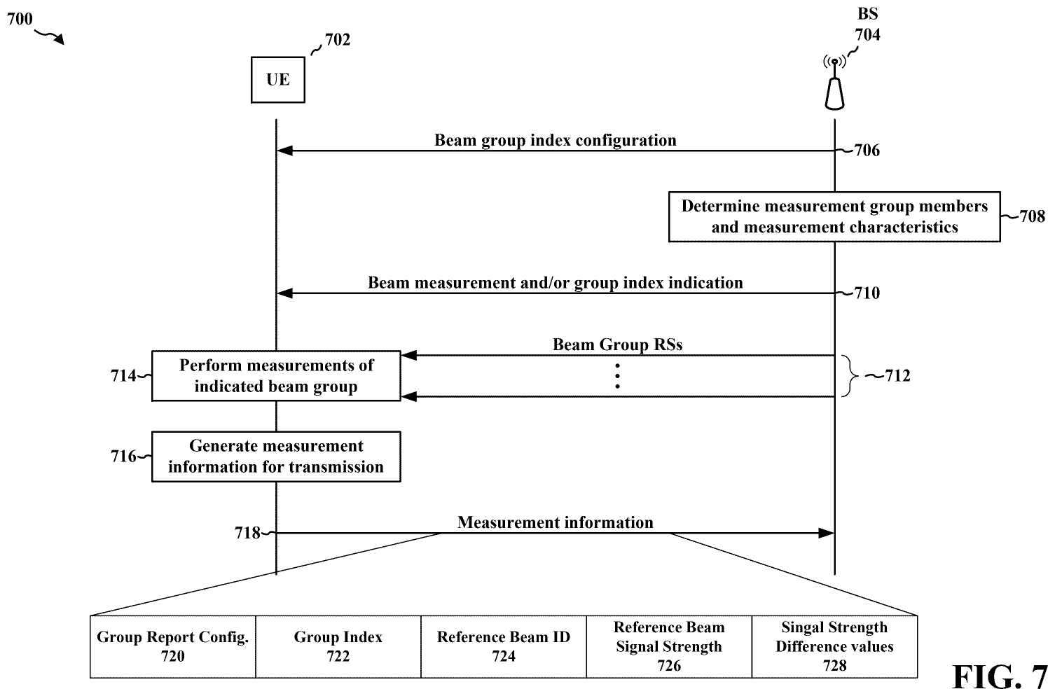

FIG. 7 is a call flow diagram 700 illustrating a set of communications between a UE 702 and a base station 704 based on a bitmap-based index and/or a combinatorial-based index in accordance with some aspects of the disclosure. The base station 704 may transmit, and UE 702 may receive, a beam-group-index configuration 706. In some aspects, the beam-group-index configuration 706 may include information regarding different CSI measurement and/or reporting parameters. The configured parameters, in some aspects, may include sets of reference signals that may be associated with measurement and/or reporting. The reference signals may be associated with different resources in frequency, time, or spatial (beamforming) domain and may be associated with identifiers. In some aspects, the ordering algorithm for generating an ordered list of resources as described in relation to FIG. 5 may be indicated in the beam-group-index configuration 706. The beam-group-index configuration 706 may be transmitted via RRC signaling and may be included in one or more of a CSI measurement configuration information element (IE) or a CSI reporting configuration IE (e.g., a CSI-MeasConfig IE or a CSI-ReportConfig IE). In some aspects, one or more mappings between combinatorial-based indexes and indicated indexes to an ordered list of resources may be include in beam-group-index configuration 706. The one or more mappings may be defined for each of a set of total number of resources N and a selected number of resources K because different choices of N and K may be associated with different numbers of possible combinations, a corresponding different number of bits used for the indication, and a different mapping.

In some aspects, the base station 704 may determine, at 708, a set of measurement group members (e.g., resources for which the base station 704 will request a CSI report) and a set of characteristics of the measurement. Determining the set of measurement group members (e.g., a first set of spatial-domain resources) may include, in some aspects, identifying a combinatorial-based index and/or a bitmap-based index associated with the measurement group members. The combinatorial-based index and/or a bitmap-based index may be identified, in some aspects, based on a number of candidate members (spatial-domain resources or beams) and a number of members in the measurement group being selected that make the combinatorial-based index and/or a bitmap-based index more efficient (e.g., use fewer bits) than a beam ID-based indication. The set of characteristics of the measurement, in some aspects, may include a type of measurement to be made (e.g., measuring reference signal received power (RSRP) such as a layer 1 (L1) RSRP, RS received quality (RSRQ), or signal to interference-and-noise ratio (SINR) such as a L1 SINR).

Based on the set of measurement group members and a set of characteristics of the measurement determined at 708, the base station 704 may transmit, and the UE 702 may receive, a beam measurement and/or group index indication 710. The beam measurement and/or group index indication 710 may be received via a MAC-CE or via DCI. The beam measurement and/or group index indication 710 may configure the UE 702 to perform a beam measurement based on the indicated measurement group members (e.g., a first set of resources, beams or beam-pairs) and the indicated measurement characteristics. Accordingly, the base station 704 may transmit RSs 712 and the UE 702 may receive the RSs 712 and perform, at 714, measurements based on the indicated measurement (or beam) group. The measurements of the RSs 712, in some aspects, may be of resources other than the first set of resources indicated in the beam measurement and/or group index indication 710, e.g., measurements may be made on a second set of resources to which ML, AI, or other analysis is applied to predict a set of values associated with the first set of resources indicated in the beam measurement and/or group index indication 710. For example, referring to FIGS. 4A and 4B, a set of measurements may be performed at 714 on a set of resources in the first set of Tx resources 410 to predict values associated with a set of resources in the second set of Tx resources 420. In some aspects, the UE 702 may receive the RSs 712 and perform the measurements based on a triggering state without an explicit indication (e.g., without receiving beam measurement and/or group index indication 710).

At 716, the UE 702 may generate measurement information for transmission as measurement information 718 (e.g., a CSI report) to the base station 704 based on the measurements performed at 714. Generating the measurement information may include generating a group report configuration 720 that may be a first part or field indicating a number of candidate resources and a number of selected resources (e.g., the numbers N and K that may be used to determine the ordered list of resources and the size of a combinatorial-based index or bitmap-based index). The group report configuration 720 may be a fixed-size part of the measurement information 718 that is used to determine and/or identify a size of a variable-sized part of the measurement information 718. The indication of the number of candidate resources and the number of selected resources may be explicit, in some aspects, or may be implicit by indicating an identifier of a particular CSI report configuration on which the measurement information is based. The group report configuration 720, in some aspects, may include a (sixth) indication that an index used in a subsequent field is one of the combinatorial-based index or the bitmap-based index instead of a set of identifiers for identifying spatial-domain resources in the first set of spatial-domain resources.

In some aspects, generating the measurement information may include generating a group index 722, e.g., the combinatorial-based index or bitmap-based index indicating the selected resources (e.g., the resources for which values are reported in the measurement information 718). The size of the group index 722, in some aspects, may be variable and may be based on the number of candidate resources or beams and a number of selected (e.g., measured and/or reported) resources or beams as indication in the group report configuration 720. For example, for a state triggered measurement, the UE 702 may report a set of 8 or 16 beams with a best measured and/or predicted signal quality (e.g., a highest RSRP such as a layer 1 (L1) RSRP, a highest RSRQ, or a highest SINR such as a L1 SINR) from a set of 32 candidate beams (or resources) using at least 24 or 30 bits, respectively. In some aspects, the group report configuration 720 (and group index 722) may be omitted for measurement information 718 requested by the base station 704 via the beam measurement and/or group index indication 710 including an indication of values for N and K (or an indication of particular spatial-domain resources such as beams or beam-pairs using beam identifiers or a combinatorial-based, or bitmap-based, index).

The UE 702, may generate at 716 a reference beam ID 724 indicating a measured resource or beam with a highest measured (or predicted) signal strength (e.g., a highest RSRP or SINR). The indication may be an identifier within the set of K selected and/or indicated resources such that the identifier may be a number of bits equal to [Log₂ K]. The identifier may be based on the known, or configured ordering of the resources applied to the set of K selected and/or indicated resources. The UE 702 may, in some aspects, generate at 716 a reference beam signal strength 726 indicating a strength of the signal associated with the resource or beam indicated in reference beam ID 724. The reference beam strength may be indicated in a set of 7 bits. The 7 bits used in the reference beam signal strength 726 may be used to indicate and/or report one of (1) a RSRP in the range of [−140,−44] dBm with a step size of 1 dBm using 97 of the possible 128 values to indicate the RSRP, or (2) a SINR in the range of [−23, 40] dB with a step size of 0.5 dB and a value of −23, in some aspects, indicating that the SINR is less than or equal to −23. The mapping of values of the 7-bit indication associate with either RSRP or SINR may be known, or configured.

In some aspects, the UE 702 may generate at 716 a set of beam strength difference values 728. Each value in the set of beam strength difference values 728, in some aspects, may indicate a difference between the signal strength indicated in reference beam signal strength 726 and the signal strength associated with a corresponding resource or beam in the set of beams indicated by group index 722. The value in the set of beam strength difference values 728, in some aspects, may be a 4-bit value. The 4 bits used in the set of beam strength difference values 728 may be used to indicate and/or report one of (1) a difference between the RSRP for the corresponding resource or beam from the highest measured RSRP in the range of [0,−30] dB with a step size of 2 dB, or (2) a difference between the SINR for the corresponding resource or beam from the highest measured SINR in the range of [0,−15] dB with a step size of 1 dB and a value of −15, in some aspects, indicating that the difference greater than or equal to −15. The mapping of values of the 4-bit indication associated with either RSRP or SINR may be known, or configured. In some aspects, the order of the set of beam strength difference values 728 may be based on the known, or configured, ordering. For example, for a set of 8 measured and/or reported resources, the reference beam ID 724 may identify a third resource in the ordered list and the set of beam strength difference values 728 may be provided according to the order of the remaining resources. For example, a first value in the set of beam strength difference values 728 may correspond to a difference between the highest reported RSRP or SINR value and a reported RSRP or SINR value for the first resource in the ordered list and a second value in the set of beam strength difference values 728 may correspond to a difference between the highest reported RSRP or SINR value and a reported RSRP or SINR value for the second resource in the ordered list. Once the index of the beam with the highest measured and/or reported RSRP or SINR value is reached (the third index) the place in the set of beam strength difference values 728 and the corresponding index into the ordered list of resources will be off by one, e.g., a third value in the set of beam strength difference values 728 may correspond to a fourth resource in the ordered list of resources.

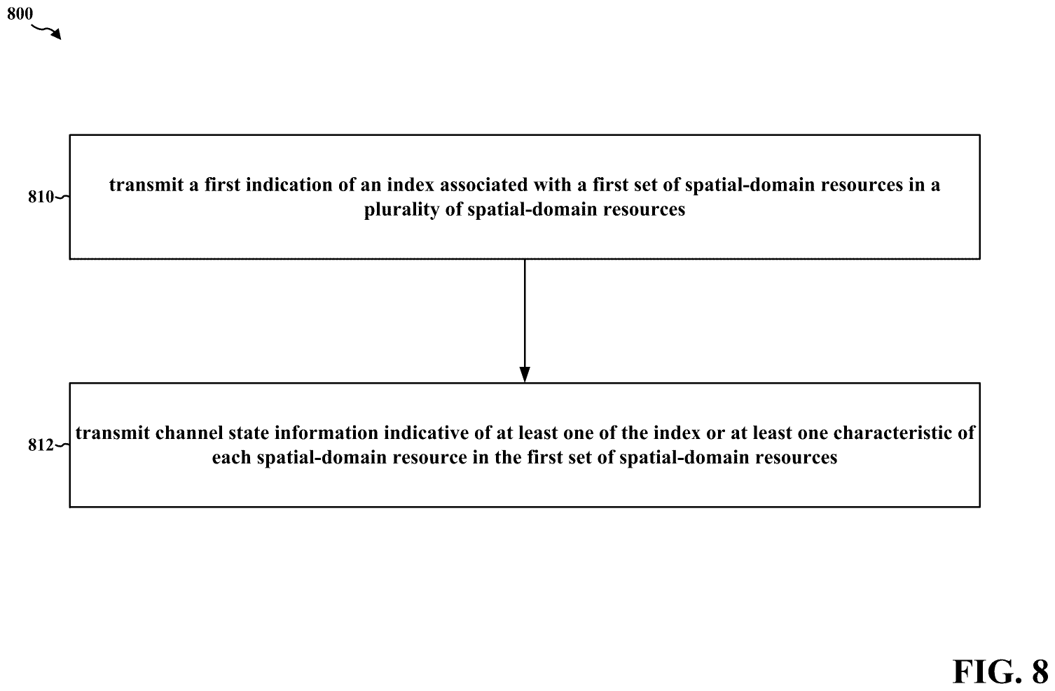

FIG. 8 is a flowchart 800 of a method of wireless communication. The method may be performed by a UE (e.g., the UE 104, 404, or 702; the apparatus 1704). The UE may receive a second indication of a first number (e.g., N) of spatial-domain resources in a plurality of spatial-domain resources. In some aspects, the plurality of spatial-domain resources is a set of spatial-domain resources configured in a CSI measurement and/or CSI report configuration received by the UE and including the second indication. The plurality of spatial-domain resources, in some aspects, may be candidate spatial-domain resources for measurement and/or reporting. For example, referring to FIGS. 4A, 4B, 4C, 5, and 7, the UE 404 or 702 may receive beam-group-index configuration 706 from base station 704 indicating a number of resources in one of the first set of Tx resources 410, the second set of Tx resources 420, resources 610, or a set of Tx-and-Rx resource-pairs.

In some aspects, the UE may receive the second indication of the first number (e.g., N) of spatial-domain resources in a configuration indication that also includes one or more of an indication to perform a measurement, an indication of an event or condition that triggers a measurement and/or CSI report, and/or an indication of a second number of spatial-domain resources for which to perform measurements or for which to report measurements. The UE may measure (e.g., based on the indication to perform the measurement or based on a triggering condition or event) at least one characteristic of at least one of a subset of a first set of spatial-domain resources in the plurality of spatial-domain resources or of each spatial-domain resource in a second set of spatial-domain resources associated with the first set of spatial-domain resources. The at least one characteristic may be identified and/or indicated in a CSI measurement and/or CSI report configuration (e.g., via RRC signaling). The at least one characteristic, in some aspects, may be an RSRP or a SINR associated with resources in at least one of the subset of the first set of spatial-domain resources in the plurality of spatial-domain resources or of each spatial-domain resource in the second set of spatial-domain resources. For example, referring to FIG. 7, the UE 702 may perform, at 714 a measurement of an RSRP or SINR for each RS in the set of RSs 712. In some aspects, the UE 702 may generate, at 716, measurement information 718 based on performing the measurement at 714 and a set of one or more of ML, AI, or other analysis applied to predict a set of values associated with the first set of resources.

The UE may transmit, based on the first number of spatial-domain resources in the plurality of spatial-domain resources and the second number of spatial-domain resources in the first set of spatial-domain resources, a (sixth) indication that an index used to identify a first set of spatial-domain resources may be one of the combinatorial-based index or the bitmap-based index instead of a set of identifiers for identifying spatial-domain resources in the first set of spatial-domain resources. The combinatorial-based index or the bitmap-based index may be used based on an associated number of bits being smaller than a number of bits associated with using the set of identifiers for identifying spatial-domain resources. For example, referring to FIG. 7, the UE 702 may transmit group report configuration 720 including the sixth indication as part of transmitting the measurement information 718.

In some aspects, the UE may transmit a third indication of a second number of spatial-domain resources in the first set of spatial-domain resources. In some aspects, the second number may be previously configured and the UE may refrain from sending the indication of the second number. The second number of spatial-domain resources, in some aspects, may reflect a number of spatial-domain resources (or beams) for which measurement information is provided. The second number of spatial-domain resources, in some aspects, may be used to determine a size of a variable-size payload associated with the combinatorial-based index or the bitmap-based index and/or a variable-sized payload associated with a set of measured and/or predicted signal strengths associated with the first set of spatial-domain resources. For example, referring to FIG. 7, the UE 702 may transmit the measurement information 718 and, more specifically, the group report configuration 720 including an indication of the number of selected resources (e.g., the second number of spatial-domain resources).

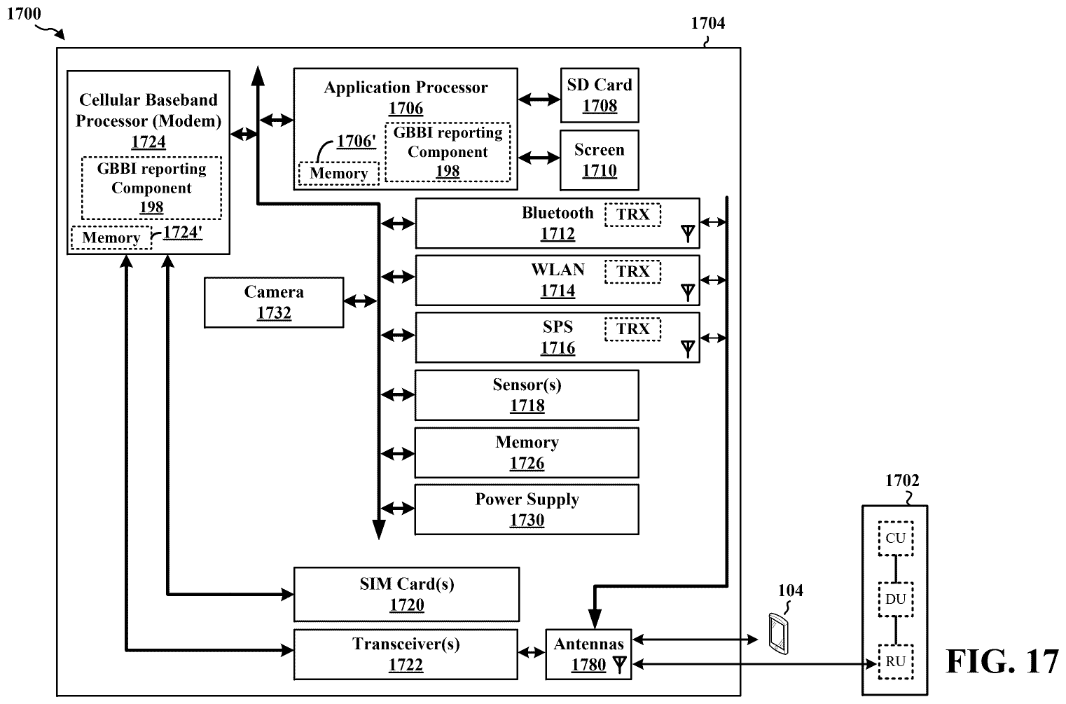

At 810, the UE may transmit a first indication of an index associated with a first set of spatial-domain resources in a plurality of spatial-domain resources. For example, 810 may be performed by application processor 1706, cellular baseband processor 1724, transceiver(s) 1722, antenna(s) 1780, and/or GBBI reporting component 198 of FIG. 17. The index, in some aspects, may be one of the combinatorial-based index or the bitmap-based index indicating the spatial-domain resources from the plurality of spatial-domain resources that are included in the first set of spatial-domain resources. In some aspects, the combinatorial-based index may include at least a third number of bits capable of representing a fourth number equal to a number of possible combinations of the second number of spatial-domain resources in the first set of spatial-domain resources selected from the first number of spatial-domain resources in the plurality of spatial-domain resources. The bitmap-based index, in some aspects, may include a number of bits equal to the first number of spatial-domain resources in the plurality of spatial-domain resources and includes a fifth number of bits indicating spatial-domain resources in the first set of spatial-domain resources, where the fifth number of bits is equal to the second number of spatial-domain resources in the first set of spatial-domain resources. In some aspects, the first indication of the index (e.g., the index itself) may be included in a CSI report, e.g., in a header of a CSI report. For example, referring to FIGS. 6 and 7, the UE 702 may transmit measurement information 718 (e.g., a CSI report) including group index 722 indicating the selected resources (e.g., the resources for which values are reported in the measurement information 718) based on the bitmap-based method 640 or the combinatorial based method 650.

At 812, the UE may transmit channel state information (e.g., in a CSI report) indicative of at least one of the index associated with the first set of spatial-domain resources or at least one characteristic of each spatial-domain resource in the first set of spatial-domain resources. For example, 812 may be performed by application processor 1706, cellular baseband processor 1724, transceiver(s) 1722, antenna(s) 1780, and/or GBBI reporting component 198 of FIG. 17. The channel state information indicative of the at least one characteristic, in some aspects, may be one of a measured or predicted signal strength associated with the resources in the first set of spatial-domain resources. In some aspects, the channel state information may be based on a measurement of the at least one characteristic of at least a subset of the first set of spatial-domain resources and may be one or more of the measured at least one characteristic or a prediction relating to the at least one characteristic. The channel state information, in some aspects, may be based on a measurement of the at least one characteristic of each of the spatial-domain resources in the second set of spatial-domain resources associated with the first set of spatial-domain resources and may be a predicted value for the at least one characteristic. The at least one characteristic, in some aspects, may be one of an RSRP or a SINR. For example, referring to FIG. 7, the UE 702 may transmit measurement information 718 (e.g., a CSI report) including group index 722, reference beam ID 724, reference beam signal strength 726, and the set of beam strength difference values 728.

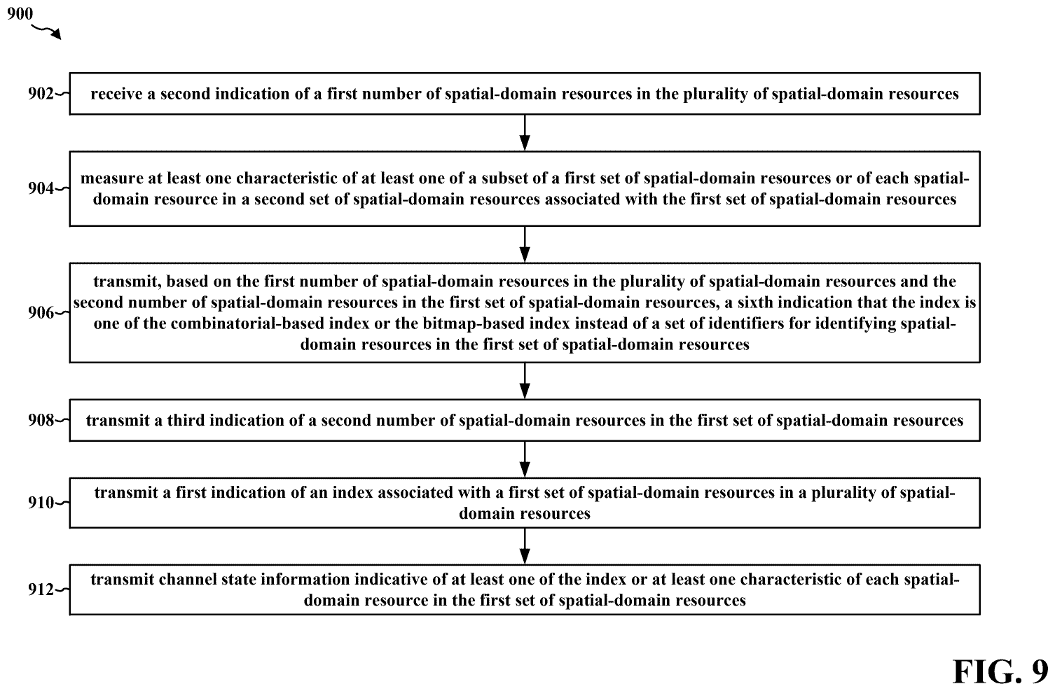

FIG. 9 is a flowchart 900 of a method of wireless communication. The method may be performed by a UE (e.g., the UE 104, 404, or 702; the apparatus 1704). At 902, the UE may receive a second indication of a first number (e.g., N) of spatial-domain resources in a plurality of spatial-domain resources. For example, 902 may be performed by application processor 1706, cellular baseband processor 1724, transceiver(s) 1722, antenna(s) 1780, and/or GBBI reporting component 198 of FIG. 17. In some aspects, the plurality of spatial-domain resources is a set of spatial-domain resources configured in a CSI measurement and/or CSI report configuration received at 902 and including the second indication. The plurality of spatial-domain resources, in some aspects, may be candidate spatial-domain resources for measurement and/or reporting. For example, referring to FIGS. 4A, 4B, 4C, 5, and 7, the UE 404 or 702 may receive beam-group-index configuration 706 from base station 704 indicating a number of resources in one of the first set of Tx resources 410, the second set of Tx resources 420, resources 610, or a set of Tx-and-Rx resource-pairs.

In some aspects, the UE may receive the second indication of the first number (e.g., N) of spatial-domain resources in a configuration indication that also includes one or more of an indication to perform a measurement, an indication of an event or condition that triggers a measurement and/or CSI report, and/or an indication of a second number of spatial-domain resources for which to perform measurements or for which to report measurements. At 904, the UE may measure (e.g., based on the indication to perform the measurement or based on a triggering condition or event) at least one characteristic of at least one of a subset of a first set of spatial-domain resources in the plurality of spatial-domain resources or of each spatial-domain resource in a second set of spatial-domain resources associated with the first set of spatial-domain resources. For example, 904 may be performed by application processor 1706, cellular baseband processor 1724, transceiver(s) 1722, antenna(s) 1780, and/or GBBI reporting component 198 of FIG. 17. The at least one characteristic may be identified and/or indicated in a CSI measurement and/or CSI report configuration received at 902 (e.g., via RRC signaling). The at least one characteristic, in some aspects, may be an RSRP or a SINR associated with resources in at least one of the subset of the first set of spatial-domain resources in the plurality of spatial-domain resources or of each spatial-domain resource in the second set of spatial-domain resources. For example, referring to FIG. 7, the UE 702 may perform, at 714 a measurement of an RSRP or SINR for each RS in the set of RSs 712. In some aspects, the UE 702 may generate, at 716, measurement information 718 (e.g., a CSI report) based on performing the measurement at 714 and a set of one or more of ML, AI, or other analysis applied to predict a set of values associated with the first set of resources.

At 906, the UE may transmit, based on the first number of spatial-domain resources in the plurality of spatial-domain resources and the second number of spatial-domain resources in the first set of spatial-domain resources, a sixth indication that the index is one of the combinatorial-based index or the bitmap-based index instead of a set of identifiers for identifying spatial-domain resources in the first set of spatial-domain resources. For example, 906 may be performed by application processor 1706, cellular baseband processor 1724, transceiver(s) 1722, antenna(s) 1780, and/or GBBI reporting component 198 of FIG. 17. The combinatorial-based index or the bitmap-based index may be used based on an associated number of bits being smaller than a number of bits associated with using the set of identifiers for identifying spatial-domain resources. For example, referring to FIG. 7, the UE 702 may transmit group report configuration 720 including the sixth indication as part of transmitting the measurement information 718 (e.g., a CSI report).

At 908, the UE may transmit a third indication of a second number of spatial-domain resources in the first set of spatial-domain resources. For example, 908 may be performed by application processor 1706, cellular baseband processor 1724, transceiver(s) 1722, antenna(s) 1780, and/or GBBI reporting component 198 of FIG. 17. In some aspects, the second number may be previously configured and the UE may refrain from sending the indication of the second number. The second number of spatial-domain resources, in some aspects, may reflect a number of spatial-domain resources (or beams) for which measurement information is provided. The second number of spatial-domain resources, in some aspects, may be used to determine a size of a variable-size payload associated with the combinatorial-based index or the bitmap-based index and/or a variable-sized payload associated with a set of measured and/or predicted signal strengths associated with the first set of spatial-domain resources. For example, referring to FIG. 7, the UE 702 may transmit the measurement information 718 (e.g., a CSI report) and, more specifically, the group report configuration 720 including an indication of the number of selected resources (e.g., the second number of spatial-domain resources).

At 910, the UE may transmit a first indication of an index associated with a first set of spatial-domain resources in a plurality of spatial-domain resources. For example, 910 may be performed by application processor 1706, cellular baseband processor 1724, transceiver(s) 1722, antenna(s) 1780, and/or GBBI reporting component 198 of FIG. 17. The index, in some aspects, may be one of the combinatorial-based index or the bitmap-based index indicating the spatial-domain resources from the plurality of spatial-domain resources that are included in the first set of spatial-domain resources. In some aspects, the combinatorial-based index may include at least a third number of bits capable of representing a fourth number equal to a number of possible combinations of the second number of spatial-domain resources in the first set of spatial-domain resources selected from the first number of spatial-domain resources in the plurality of spatial-domain resources. The bitmap-based index, in some aspects, may include a number of bits equal to the first number of spatial-domain resources in the plurality of spatial-domain resources and includes a fifth number of bits indicating spatial-domain resources in the first set of spatial-domain resources, where the fifth number of bits is equal to the second number of spatial-domain resources in the first set of spatial-domain resources. In some aspects, the first indication of the index (e.g., the index itself) may be included in a CSI report, e.g., in a header of a CSI report. For example, referring to FIGS. 6 and 7, the UE 702 may transmit measurement information 718 (e.g., a CSI report) including group index 722 indicating the selected resources (e.g., the resources for which values are reported in the measurement information 718) based on the bitmap-based method 640 or the combinatorial based method 650.

Finally, at 912, the UE may transmit channel state information (e.g., in a CSI report) indicative of at least one of the index associated with the first set of spatial-domain resources or at least one characteristic of each spatial-domain resource in the first set of spatial-domain resources. For example, 912 may be performed by application processor 1706, cellular baseband processor 1724, transceiver(s) 1722, antenna(s) 1780, and/or GBBI reporting component 198 of FIG. 17. The channel state information indicative of the at least one characteristic, in some aspects, may be one of a measured or predicted signal strength associated with the resources in the first set of spatial-domain resources. In some aspects, the channel state information may be based on a measurement of the at least one characteristic of at least a subset of the first set of spatial-domain resources and may be one or more of the measured at least one characteristic or a prediction relating to the at least one characteristic. The channel state information, in some aspects, may be based on a measurement of the at least one characteristic of each of the spatial-domain resources in the second set of spatial-domain resources associated with the first set of spatial-domain resources and may be a predicted value for the at least one characteristic. The at least one characteristic, in some aspects, may be one of an RSRP or a SINR. For example, referring to FIG. 7, the UE 702 may transmit measurement information 718 (e.g., a CSI report) including group index 722, reference beam ID 724, reference beam signal strength 726, and the set of beam strength difference values 728.

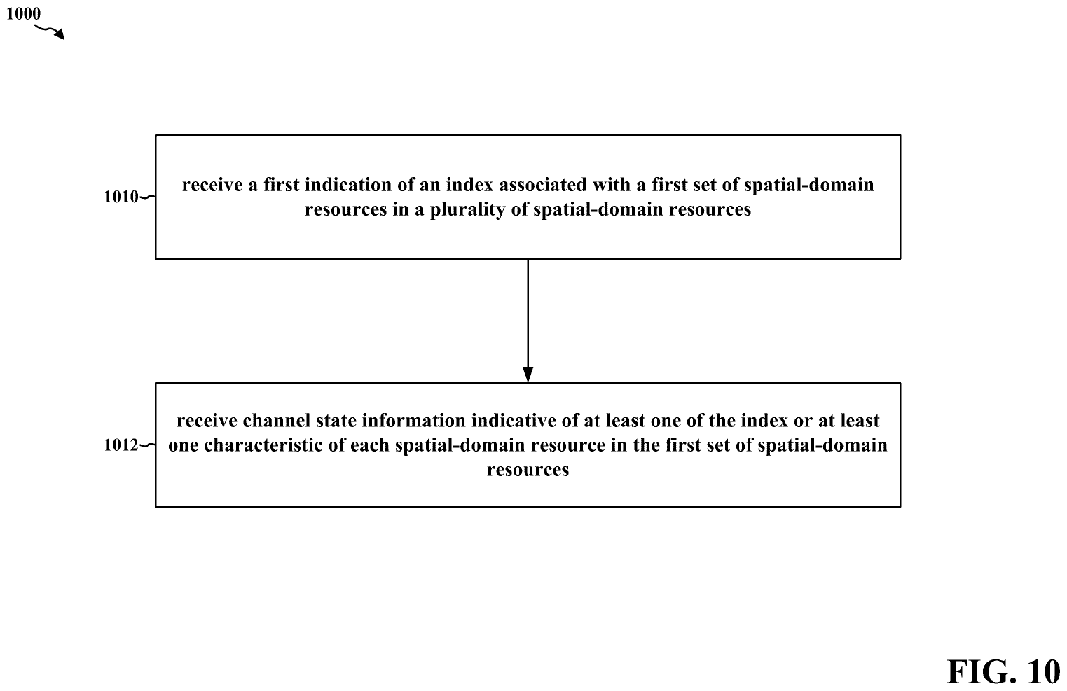

FIG. 10 is a flowchart 1000 of a method of wireless communication. The method may be performed by a base station (e.g., the base station 102, 402, or 704; the network entity 1802). The base station may transmit a second indication of a first number (e.g., N) of spatial-domain resources in a plurality of spatial-domain resources. In some aspects, the plurality of spatial-domain resources is a set of spatial-domain resources configured in a CSI measurement and/or CSI report configuration transmitted by the base station and including the second indication. The plurality of spatial-domain resources, in some aspects, may be candidate spatial-domain resources for measurement and/or reporting. For example, referring to FIGS. 4A, 4B, 4C, 5, and 7, the base station 402 or 704 may transmit beam-group-index configuration 706 to UE 702 indicating a number of resources in one of the first set of Tx resources 410, the second set of Tx resources 420, resources 610, or a set of Tx-and-Rx resource-pairs.

In some aspects, the base station may transmit the second indication of the first number (e.g., N) of spatial-domain resources in a configuration indication that also includes one or more of an indication to perform a measurement, an indication of an event or condition that triggers a measurement and/or CSI report, and/or an indication of a second number of spatial-domain resources for which to perform measurements or for which to report measurements. The base station, in some aspects, may receive information regarding a first set of spatial-domain resources in the plurality of spatial-domain resources. The information, in some aspects, may be received from a UE based on a measurement of at least one characteristic of at least one of a subset of the first set of spatial-domain resources in the plurality of spatial-domain resources or of each spatial-domain resource in a second set of spatial-domain resources associated with the first set of spatial-domain resources. The at least one characteristic may be identified and/or indicated in a CSI measurement and/or CSI report configuration transmitted by the base station (e.g., via RRC signaling). The at least one characteristic, in some aspects, may be an RSRP or a SINR associated with resources in at least one of the subset of the first set of spatial-domain resources in the plurality of spatial-domain resources or of each spatial-domain resource in the second set of spatial-domain resources. For example, referring to FIG. 7, the base station may receive measurement information 718 (e.g., a CSI report) from UE 702 based on the UE 702 performing the measurement at 714 and a set of one or more of ML, AI, or other analysis applied to predict a set of values associated with the first set of resources.

As part of receiving the information regarding the first set of spatial-domain resources, the base station may receive a third indication of a second number of spatial-domain resources in the first set of spatial-domain resources (e.g., if not previously configured). The second number of spatial-domain resources, in some aspects, may reflect a number of spatial-domain resources (or beams) for which measurement information is provided. The second number of spatial-domain resources, in some aspects, may be used to determine a size of a variable-size payload associated with the combinatorial-based index or the bitmap-based index and/or a variable-sized payload associated with a set of measured and/or predicted signal strengths associated with the first set of spatial-domain resources. For example, referring to FIG. 7, the base station 704 may receive the measurement information 718 (e.g., a CSI report) and, more specifically, the group report configuration 720 including an indication of the number of selected resources (e.g., the second number of spatial-domain resources).

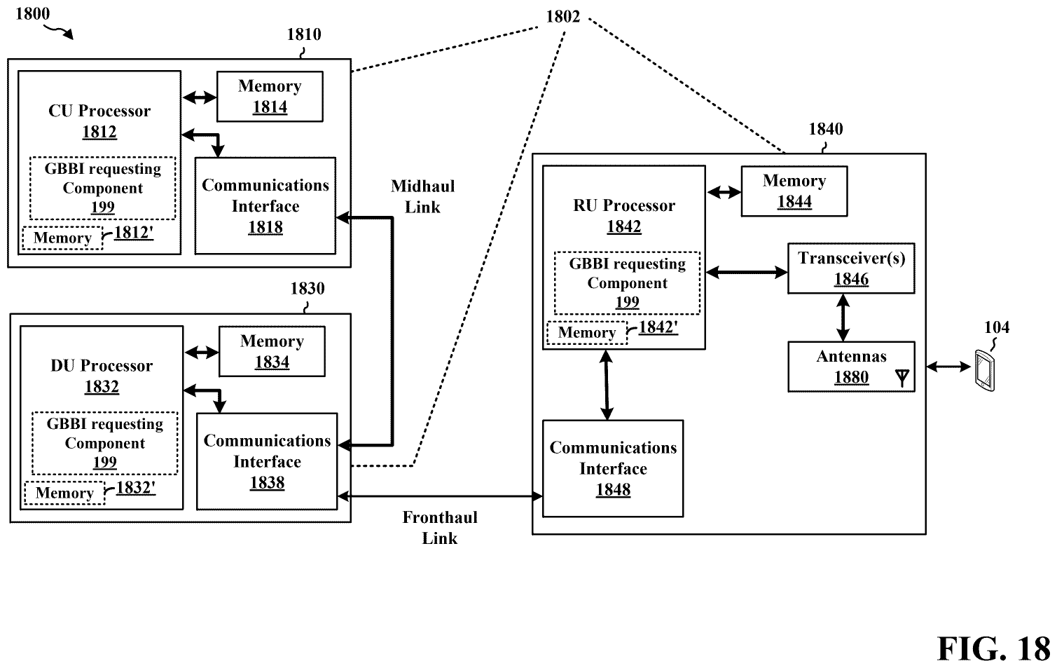

As part of receiving the information regarding the first set of spatial-domain resources, the base station may receive based on the first number of spatial-domain resources in the plurality of spatial-domain resources and the second number of spatial-domain resources in the first set of spatial-domain resources, a sixth indication that the index is one of the combinatorial-based index or the bitmap-based index instead of a set of identifiers for identifying spatial-domain resources in the first set of spatial-domain resources. For example, 1008 may be performed by CU processor 1812, DU processor 1832, RU processor 1842, transceiver(s) 1846, antenna(s) 1880, and/or GBBI requesting component 199 of FIG. 18. The combinatorial-based index or the bitmap-based index may be used based on an associated number of bits being smaller than a number of bits associated with using the set of identifiers for identifying spatial-domain resources. For example, referring to FIG. 7, the base station 704 may receive group report configuration 720 including the sixth indication as part of receiving the measurement information 718 (e.g., a CSI report).

At 1010, the base station may receive a first indication of an index associated with a first set of spatial-domain resources in a plurality of spatial-domain resources. In some aspects, the first indication may be received at 1010 as part of receiving the information regarding the first set of spatial-domain resources. For example, 1010 may be performed by CU processor 1812, DU processor 1832, RU processor 1842, transceiver(s) 1846, antenna(s) 1880, and/or GBBI requesting component 199 of FIG. 18. The index, in some aspects, may be one of the combinatorial-based index or the bitmap-based index indicating the spatial-domain resources from the plurality of spatial-domain resources that are included in the first set of spatial-domain resources. In some aspects, the combinatorial-based index may include at least a third number of bits capable of representing a fourth number equal to a number of possible combinations of the second number of spatial-domain resources in the first set of spatial-domain resources selected from the first number of spatial-domain resources in the plurality of spatial-domain resources. The bitmap-based index, in some aspects, may include a number of bits equal to the first number of spatial-domain resources in the plurality of spatial-domain resources and includes a fifth number of bits indicating spatial-domain resources in the first set of spatial-domain resources, where the fifth number of bits is equal to the second number of spatial-domain resources in the first set of spatial-domain resources. For example, referring to FIGS. 6 and 7, the UE 702 may transmit measurement information 718 (e.g., a CSI report) including group index 722 indicating the selected resources (e.g., the resources for which values are reported in the measurement information 718) based on the bitmap-based method 640 or the combinatorial based method 650.

At 1012, the base station may receive channel state information (e.g., a CSI report) indicative of at least one of the index associated with the first set of spatial-domain resources or at least one characteristic of each spatial-domain resource in the first set of spatial-domain resources. In some aspects, the channel state information indicative of at least one characteristic of each spatial-domain resource in the first set of spatial-domain resources is received at 1012 as part of receiving the information regarding the first set of spatial-domain resources. For example, 1012 may be performed by CU processor 1812, DU processor 1832, RU processor 1842, transceiver(s) 1846, antenna(s) 1880, and/or GBBI requesting component 199 of FIG. 18. The channel state information indicative of the at least one characteristic, in some aspects, may be one of a measured or predicted signal strength associated with the resources in the first set of spatial-domain resources. In some aspects, the channel state information may be based on a measurement of the at least one characteristic of at least a subset of the first set of spatial-domain resources and may be one or more of the measured at least one characteristic or a prediction relating to the at least one characteristic. The channel state information, in some aspects, may be based on a measurement of the at least one characteristic of each of the spatial-domain resources in the second set of spatial-domain resources associated with the first set of spatial-domain resources and may be a predicted value for the at least one characteristic. For example, referring to FIG. 7, the base station 704 may receive measurement information 718 (e.g., a CSI report) including group index 722, reference beam ID 724, reference beam signal strength 726, and the set of beam strength difference values 728.

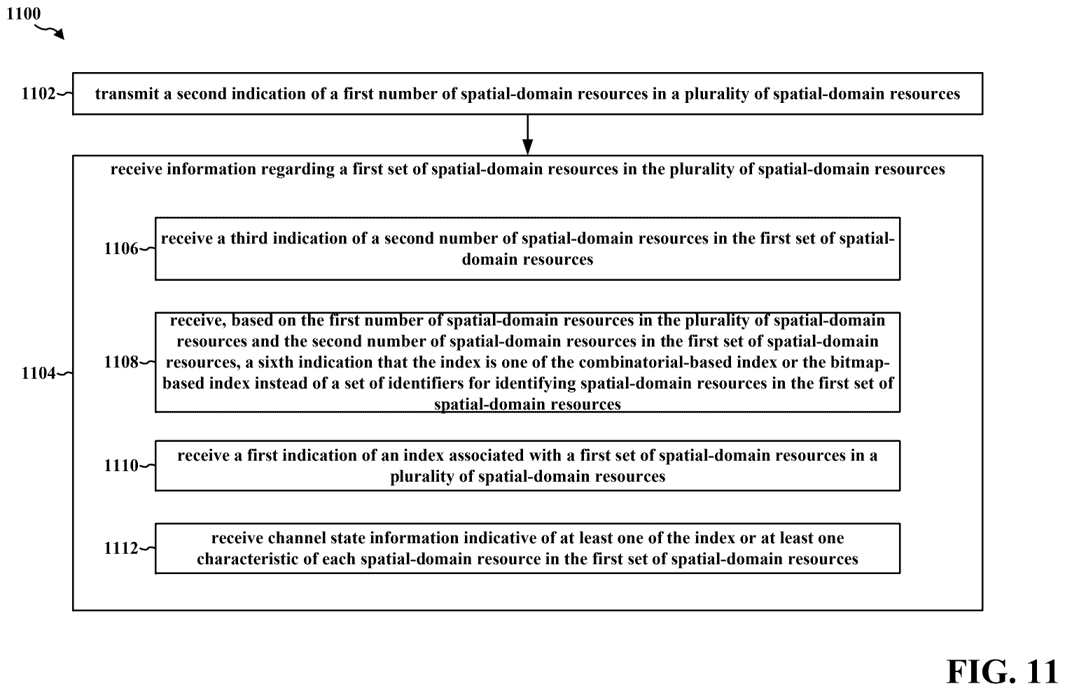

FIG. 11 is a flowchart 1100 of a method of wireless communication. The method may be performed by a base station (e.g., the base station 102, 402, or 704; the network entity 1802). At 1102, the base station may transmit a second indication of a first number (e.g., N) of spatial-domain resources in a plurality of spatial-domain resources. For example, 1102 may be performed by CU processor 1812, DU processor 1832, RU processor 1842, transceiver(s) 1846, antenna(s) 1880, and/or GBBI requesting component 199 of FIG. 18. In some aspects, the plurality of spatial-domain resources is a set of spatial-domain resources configured in a CSI measurement and/or CSI report configuration transmitted at 1102 and including the second indication. The plurality of spatial-domain resources, in some aspects, may be candidate spatial-domain resources for measurement and/or reporting. For example, referring to FIGS. 4A, 4B, 4C, 5, and 7, the base station 402 or 704 may transmit beam-group-index configuration 706 to UE 702 indicating a number of resources in one of the first set of Tx resources 410, the second set of Tx resources 420, resources 610, or a set of Tx-and-Rx resource-pairs.

In some aspects, the base station may transmit the second indication of the first number (e.g., N) of spatial-domain resources in a configuration indication that also includes one or more of an indication to perform a measurement, an indication of an event or condition that triggers a measurement and/or CSI report, and/or an indication of a second number of spatial-domain resources for which to perform measurements or for which to report measurements. At 1104, the base station, in some aspects, may receive information regarding a first set of spatial-domain resources in the plurality of spatial-domain resources. For example, 1104 may be performed by CU processor 1812, DU processor 1832, RU processor 1842, transceiver(s) 1846, antenna(s) 1880, and/or GBBI requesting component 199 of FIG. 18. The information received at 1104, in some aspects, may be received from a UE based on a measurement of at least one characteristic of at least one of a subset of the first set of spatial-domain resources in the plurality of spatial-domain resources or of each spatial-domain resource in a second set of spatial-domain resources associated with the first set of spatial-domain resources. The at least one characteristic may be identified and/or indicated in a CSI measurement and/or CSI report configuration transmitted at 1102 (e.g., via RRC signaling). The at least one characteristic, in some aspects, may be an RSRP or a SINR associated with resources in at least one of the subset of the first set of spatial-domain resources in the plurality of spatial-domain resources or of each spatial-domain resource in the second set of spatial-domain resources. For example, referring to FIG. 7, the base station may receive measurement information 718 (e.g., a CSI report) from UE 702 based on the UE 702 performing the measurement at 714 and a set of one or more of ML, AI, or other analysis applied to predict a set of values associated with the first set of resources.

As part of receiving the information regarding the first set of spatial-domain resources at 1104, the base station may receive, at 1106, a third indication of a second number of spatial-domain resources in the first set of spatial-domain resources (e.g., if not previously configured). For example, 1106 may be performed by CU processor 1812, DU processor 1832, RU processor 1842, transceiver(s) 1846, antenna(s) 1880, and/or GBBI requesting component 199 of FIG. 18. The second number of spatial-domain resources, in some aspects, may reflect a number of spatial-domain resources (or beams) for which measurement information is provided. The second number of spatial-domain resources, in some aspects, may be used to determine a size of a variable-size payload associated with the combinatorial-based index or the bitmap-based index and/or a variable-sized payload associated with a set of measured and/or predicted signal strengths associated with the first set of spatial-domain resources. For example, referring to FIG. 7, the base station 704 may receive the measurement information 718 (e.g., a CSI report) and, more specifically, the group report configuration 720 including an indication of the number of selected resources (e.g., the second number of spatial-domain resources).

As part of receiving the information regarding the first set of spatial-domain resources at 1104, the base station may receive, at 1108, based on the first number of spatial-domain resources in the plurality of spatial-domain resources and the second number of spatial-domain resources in the first set of spatial-domain resources, a sixth indication that the index is one of the combinatorial-based index or the bitmap-based index instead of a set of identifiers for identifying spatial-domain resources in the first set of spatial-domain resources. For example, 1108 may be performed by CU processor 1812, DU processor 1832, RU processor 1842, transceiver(s) 1846, antenna(s) 1880, and/or GBBI requesting component 199 of FIG. 18. The combinatorial-based index or the bitmap-based index may be used based on an associated number of bits being smaller than a number of bits associated with using the set of identifiers for identifying spatial-domain resources. For example, referring to FIG. 7, the base station 704 may receive group report configuration 720 including the sixth indication as part of receiving the measurement information 718 (e.g., a CSI report).

As part of receiving the information regarding the first set of spatial-domain resources at 1104, the base station may receive, at 1110, a first indication of an index associated with a first set of spatial-domain resources in a plurality of spatial-domain resources. For example, 1110 may be performed by CU processor 1812, DU processor 1832, RU processor 1842, transceiver(s) 1846, antenna(s) 1880, and/or GBBI requesting component 199 of FIG. 18. The index, in some aspects, may be one of the combinatorial-based index or the bitmap-based index indicating the spatial-domain resources from the plurality of spatial-domain resources that are included in the first set of spatial-domain resources. In some aspects, the combinatorial-based index may include at least a third number of bits capable of representing a fourth number equal to a number of possible combinations of the second number of spatial-domain resources in the first set of spatial-domain resources selected from the first number of spatial-domain resources in the plurality of spatial-domain resources. The bitmap-based index, in some aspects, may include a number of bits equal to the first number of spatial-domain resources in the plurality of spatial-domain resources and includes a fifth number of bits indicating spatial-domain resources in the first set of spatial-domain resources, where the fifth number of bits is equal to the second number of spatial-domain resources in the first set of spatial-domain resources. For example, referring to FIGS. 6 and 7, the UE 702 may transmit measurement information 718 (e.g., a CSI report) including group index 722 indicating the selected resources (e.g., the resources for which values are reported in the measurement information 718) based on the bitmap-based method 640 or the combinatorial based method 650.

Finally, at 1112, the base station may receive, as part of receiving the information regarding the first set of spatial-domain resources at 1104, channel state information (e.g., a CSI report) indicative of at least one of the index associated with the first set of spatial-domain resources or at least one characteristic of each spatial-domain resource in the first set of spatial-domain resources. For example, 1112 may be performed by CU processor 1812, DU processor 1832, RU processor 1842, transceiver(s) 1846, antenna(s) 1880, and/or GBBI requesting component 199 of FIG. 18. The channel state information indicative of the at least one characteristic, in some aspects, may be one of a measured or predicted signal strength associated with the resources in the first set of spatial-domain resources. In some aspects, the channel state information may be based on a measurement of the at least one characteristic of at least a subset of the first set of spatial-domain resources and may be one or more of the measured at least one characteristic or a prediction relating to the at least one characteristic. The channel state information, in some aspects, may be based on a measurement of the at least one characteristic of each of the spatial-domain resources in the second set of spatial-domain resources associated with the first set of spatial-domain resources and may be a predicted value for the at least one characteristic. For example, referring to FIG. 7, the base station 704 may receive measurement information 718 (e.g., a CSI report) including group index 722, reference beam ID 724, reference beam signal strength 726, and the set of beam strength difference values 728.

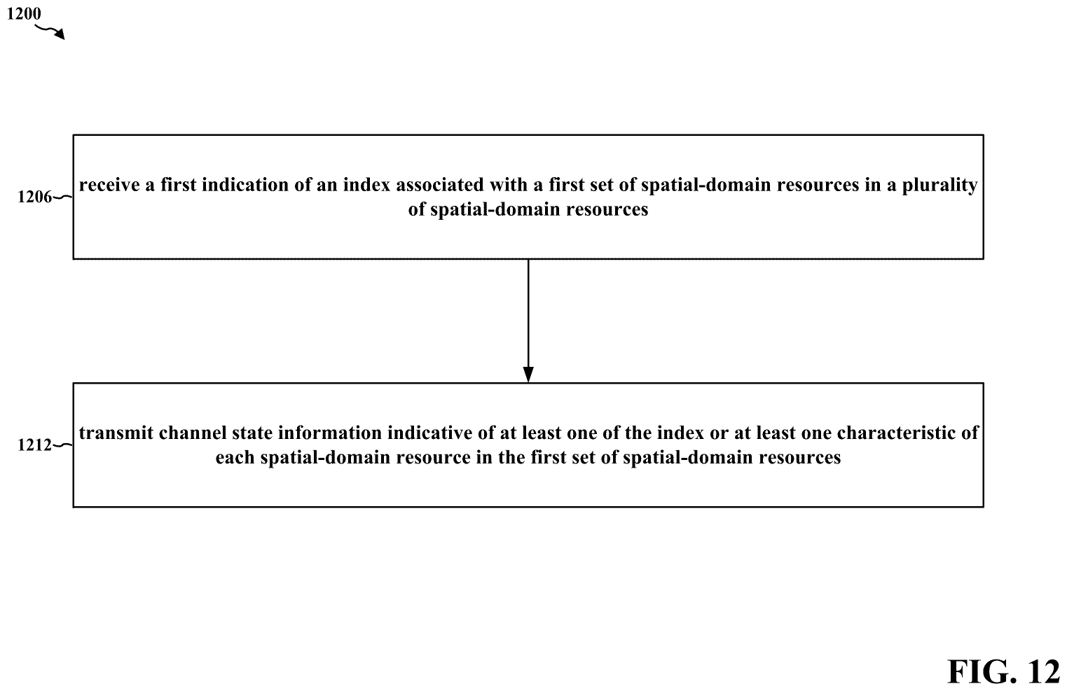

FIG. 12 is a flowchart 1200 of a method of wireless communication. The method may be performed by a UE (e.g., the UE 104, 404, or 702; the apparatus 1704). The UE may receive a second indication of a first number (e.g., N) of spatial-domain resources in a plurality of spatial-domain resources. In some aspects, the plurality of spatial-domain resources is a set of spatial-domain resources configured in a CSI measurement and/or CSI report configuration received by the UE and including the second indication. The plurality of spatial-domain resources, in some aspects, may be candidate spatial-domain resources for measurement and/or reporting. For example, referring to FIGS. 4A, 4B, 4C, 5, and 7, the UE 404 or 702 may receive beam-group-index configuration 706 from base station 704 indicating a number of resources in one of the first set of Tx resources 410, the second set of Tx resources 420, resources 610, or a set of Tx-and-Rx resource-pairs.

The UE may receive a third indication of a second number of spatial-domain resources in a first set of spatial-domain resources. In some aspects, the first set of spatial-domain resources are a set (or subset) of spatial-domain resources configured in the CSI measurement and/or CSI report configuration received by the UE. The second number of spatial-domain resources, in some aspects, may reflect a number of spatial-domain resources (e.g., beams or beam-pairs) for which measurement information is requested. The second number of spatial-domain resources, in some aspects, may be used to determine a size of a variable-size payload associated with the combinatorial-based index or the bitmap-based index and/or a variable-sized payload associated with a set of measured and/or predicted signal strengths associated with the first set of spatial-domain resources. In some aspects, the second number of spatial-domain resources may be used to define a mapping (e.g., identify a particular mapping from a set of potential mappings) between a combinatorial-based index and a set of spatial-domain resources indicated by the index. For example, referring to FIG. 7, the UE 702 may receive beam measurement and/or group index indication 710 indicating a number of resources associated with a request for CSI from the UE 702.

At 1206, the UE may receive a first indication of an index associated with a first set of spatial-domain resources in a plurality of spatial-domain resources. For example, 1206 may be performed by application processor 1706, cellular baseband processor 1724, transceiver(s) 1722, antenna(s) 1780, and/or GBBI reporting component 198 of FIG. 17. The index, in some aspects, may be one of a combinatorial-based index or the bitmap-based index indicating the spatial-domain resources from the plurality of spatial-domain resources that are included in the first set of spatial-domain resources. In some aspects, the combinatorial-based index may include at least a third number of bits capable of representing a fourth number equal to a number of possible combinations of the second number of spatial-domain resources in the first set of spatial-domain resources selected from the first number of spatial-domain resources in the plurality of spatial-domain resources. The bitmap-based index, in some aspects, may include a number of bits equal to the first number of spatial-domain resources in the plurality of spatial-domain resources and includes a fifth number of bits indicating spatial-domain resources in the first set of spatial-domain resources, where the fifth number of bits is equal to the second number of spatial-domain resources in the first set of spatial-domain resources. For example, referring to FIGS. 6 and 7, the UE 702 may receive a combinatorial-based index or bitmap-based index in beam measurement and/or group index indication 710 indicating a set of spatial-domain resources for which to provide measurement information 718 (e.g., a CSI report) based on the bitmap-based method 640 or the combinatorial based method 650.

The UE may receive a fourth indication that at least one characteristic to be measured and/or reported for the first set of spatial-domain resources is one or a RSRP or a SINR and a fifth indication for the UE to measure the at least one characteristic. The fourth indication, in some aspects may be included in RRC signaling or the fourth and fifth indication may be included in a MAC-CE or DCI. For example, referring to FIG. 7, the UE 702 may receive an indication of a type of measurement or value to include in a measurement information 718 (e.g., a CSI report) via beam-group-index configuration 706 or beam measurement and/or group index indication 710. In some aspects, the beam measurement and/or group index indication 710 may be received via a MAC-CE or DCI.

Based on the index received at 1206 and the fourth and fifth indications, the UE, in some aspects, may measure the at least one characteristic of at least one of a subset of a first set of spatial-domain resources in the plurality of spatial-domain resources or of each spatial-domain resource in a second set of spatial-domain resources associated with the first set of spatial-domain resources. The at least one characteristic may be identified and/or indicated in a CSI measurement and/or CSI report configuration received at by the UE (e.g., via RRC signaling) or via the MAC-CE or DCI associated with the reception of the first indication received at 1206 and fourth and fifth indications. The at least one characteristic, in some aspects, may be an RSRP or a SINR associated with resources in at least one of the subset of the first set of spatial-domain resources in the plurality of spatial-domain resources or of each spatial-domain resource in the second set of spatial-domain resources. For example, referring to FIG. 7, the UE 702 may perform, at 714 a measurement of an RSRP or SINR for each RS in the set of RSs 712. In some aspects, the UE 702 may generate, at 716, measurement information 718 (e.g., a CSI report) based on performing the measurement at 714 and a set of one or more of ML, AI, or other analysis applied to predict a set of values associated with the first set of resources.

Based on the measurement, at 1212, the UE may transmit channel state information (e.g., a CSI report) indicative of at least one of the index associated with the first set of spatial-domain resources or the at least one characteristic of each spatial-domain resource in the first set of spatial-domain resources. For example, 1212 may be performed by application processor 1706, cellular baseband processor 1724, transceiver(s) 1722, antenna(s) 1780, and/or GBBI reporting component 198 of FIG. 17. The channel state information indicative of the at least one characteristic, in some aspects, may be one of a measured or predicted signal strength associated with the resources in the first set of spatial-domain resources. In some aspects, the channel state information may be based on the measurement of the at least one characteristic of at least a subset of the first set of spatial-domain resources and may be one or more of the measured at least one characteristic or a prediction relating to the at least one characteristic. The channel state information, in some aspects, may be based on the measurement of the at least one characteristic of each of the spatial-domain resources in the second set of spatial-domain resources associated with the first set of spatial-domain resources and may be a predicted value for the at least one characteristic. The predicted value, in some aspects, may be based on a ML, AI, or other analysis of the measurements made by the UE. In some aspects, the channel state information indicative of the at least one characteristic may further include an indication of one or more of the first number of spatial-domain resources in the plurality of spatial-domain resources, the second number of spatial-domain resources in the first set of spatial-domain resources, and the index associated with the first set of spatial-domain resources. For example, referring to FIG. 7, the UE 702 may transmit measurement information 718 (e.g., a CSI report) including group index 722, group report configuration 720, group index 722, reference beam ID 724, reference beam signal strength 726, and the set of beam strength difference values 728.

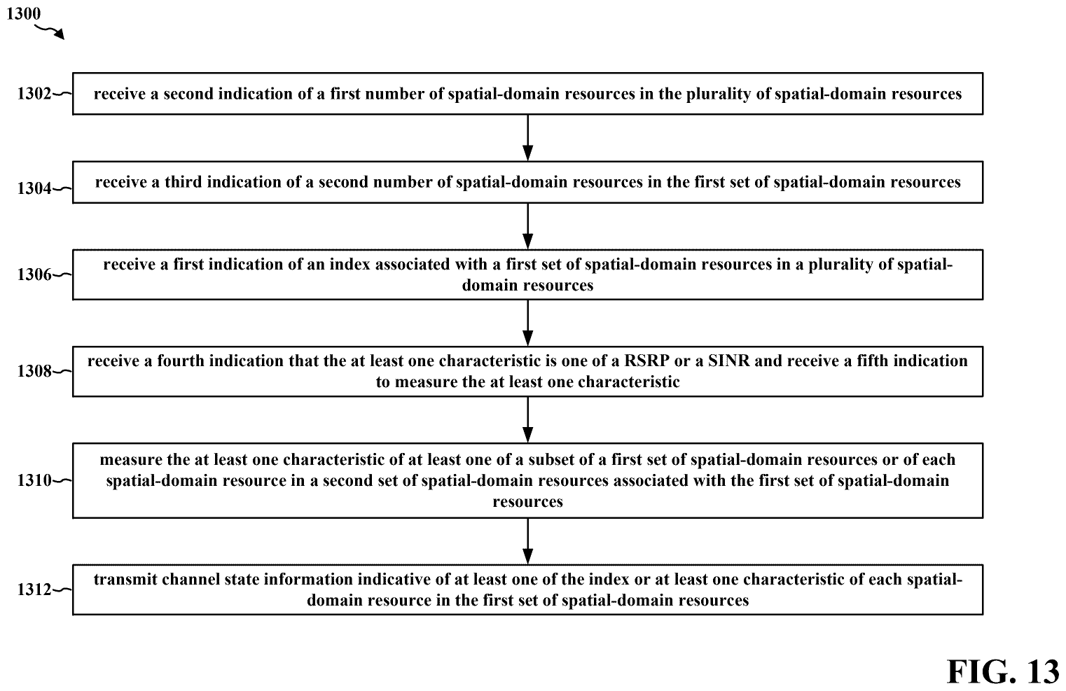

FIG. 13 is a flowchart 1300 of a method of wireless communication. The method may be performed by a UE (e.g., the UE 104, 404, or 702; the apparatus 1704). At 1302, the UE may receive a second indication of a first number (e.g., N) of spatial-domain resources in a plurality of spatial-domain resources. For example, 1302 may be performed by application processor 1706, cellular baseband processor 1724, transceiver(s) 1722, antenna(s) 1780, and/or GBBI reporting component 198 of FIG. 17. In some aspects, the plurality of spatial-domain resources is a set of spatial-domain resources configured in a CSI measurement and/or CSI report configuration received at 1302 and including the second indication. The plurality of spatial-domain resources, in some aspects, may be candidate spatial-domain resources for measurement and/or reporting. For example, referring to FIGS. 4A, 4B, 4C, 5, and 7, the UE 404 or 702 may receive beam-group-index configuration 706 from base station 704 indicating a number of resources in one of the first set of Tx resources 410, the second set of Tx resources 420, resources 610, or a set of Tx-and-Rx resource-pairs.

At 1304, the UE may receive a third indication of a second number of spatial-domain resources in a first set of spatial-domain resources. For example, 1304 may be performed by application processor 1706, cellular baseband processor 1724, transceiver(s) 1722, antenna(s) 1780, and/or GBBI reporting component 198 of FIG. 17. In some aspects, the first set of spatial-domain resources are a set (or subset) of spatial-domain resources configured in the CSI measurement and/or CSI report configuration received at 1302. The second number of spatial-domain resources, in some aspects, may reflect a number of spatial-domain resources (e.g., beams or beam-pairs) for which measurement information is requested. The second number of spatial-domain resources, in some aspects, may be used to determine a size of a variable-size payload associated with the combinatorial-based index or the bitmap-based index and/or a variable-sized payload associated with a set of measured and/or predicted signal strengths associated with the first set of spatial-domain resources. In some aspects, the second number of spatial-domain resources may be used to define a mapping (e.g., identify a particular mapping from a set of potential mappings) between a combinatorial-based index and a set of spatial-domain resources indicated by the index. For example, referring to FIG. 7, the UE 702 may receive beam measurement and/or group index indication 710 indicating a number of resources associated with a request for CSI from the UE 702.

At 1306, the UE may receive a first indication of an index associated with a first set of spatial-domain resources in a plurality of spatial-domain resources. For example, 1306 may be performed by application processor 1706, cellular baseband processor 1724, transceiver(s) 1722, antenna(s) 1780, and/or GBBI reporting component 198 of FIG. 17. The index, in some aspects, may be one of a combinatorial-based index or the bitmap-based index indicating the spatial-domain resources from the plurality of spatial-domain resources that are included in the first set of spatial-domain resources. In some aspects, the combinatorial-based index may include at least a third number of bits capable of representing a fourth number equal to a number of possible combinations of the second number of spatial-domain resources in the first set of spatial-domain resources selected from the first number of spatial-domain resources in the plurality of spatial-domain resources. The bitmap-based index, in some aspects, may include a number of bits equal to the first number of spatial-domain resources in the plurality of spatial-domain resources and includes a fifth number of bits indicating spatial-domain resources in the first set of spatial-domain resources, where the fifth number of bits is equal to the second number of spatial-domain resources in the first set of spatial-domain resources. For example, referring to FIGS. 6 and 7, the UE 702 may receive a combinatorial-based index or bitmap-based index in beam measurement and/or group index indication 710 indicating a set of spatial-domain resources for which to provide measurement information 718 (e.g., a CSI report) based on the bitmap-based method 640 or the combinatorial based method 650.

At 1308, the UE may receive a fourth indication that at least one characteristic to be measured and/or reported for the first set of spatial-domain resources is one or a RSRP or a SINR and a fifth indication for the UE to measure the at least one characteristic. For example, 1308 may be performed by application processor 1706, cellular baseband processor 1724, transceiver(s) 1722, antenna(s) 1780, and/or GBBI reporting component 198 of FIG. 17. The fourth indication, in some aspects may be included in RRC signaling or the fourth and fifth indication may be included in a MAC-CE or DCI. For example, referring to FIG. 7, the UE 702 may receive an indication of a type of measurement or value to include in a measurement information 718 (e.g., a CSI report) via beam-group-index configuration 706 or beam measurement and/or group index indication 710. In some aspects, the beam measurement and/or group index indication 710 may be received via a MAC-CE or DCI.

At 1310, the UE may measure at least one characteristic of at least one of a subset of a first set of spatial-domain resources in the plurality of spatial-domain resources or of each spatial-domain resource in a second set of spatial-domain resources associated with the first set of spatial-domain resources. For example, 1310 may be performed by application processor 1706, cellular baseband processor 1724, and/or GBBI reporting component 198 of FIG. 17. The measurement at 1301, in some aspects, may be based on the index received at 1306 and the fourth and fifth indications received at 1308. The at least one characteristic may be identified and/or indicated in a CSI measurement and/or CSI report configuration received at 1302 (e.g., via RRC signaling) or via the MAC-CE or DCI associated with the reception of the third indication, the first indication, and the fourth and fifth indications received at 1304, 1306, and 1308, respectively. The at least one characteristic, in some aspects, may be an RSRP or a SINR associated with resources in at least one of the subset of the first set of spatial-domain resources in the plurality of spatial-domain resources or of each spatial-domain resource in the second set of spatial-domain resources. For example, referring to FIG. 7, the UE 702 may perform, at 714 a measurement of an RSRP or SINR for each RS in the set of RSs 712. In some aspects, the UE 702 may generate, at 716, measurement information 718 (e.g., a CSI report) based on performing the measurement at 714 and a set of one or more of ML, AI, or other analysis applied to predict a set of values associated with the first set of resources.

Finally, at 1312, the UE may transmit channel state information (e.g., a CSI report) indicative of at least one of the index associated with the first set of spatial-domain resources or the at least one characteristic of each spatial-domain resource in the first set of spatial-domain resources. For example, 1312 may be performed by application processor 1706, cellular baseband processor 1724, transceiver(s) 1722, antenna(s) 1780, and/or GBBI reporting component 198 of FIG. 17. The channel state information indicative of the at least one characteristic, in some aspects, may be one of a measured or predicted signal strength associated with the resources in the first set of spatial-domain resources. In some aspects, the channel state information may be based on the measurement, at 1310, of the at least one characteristic of at least a subset of the first set of spatial-domain resources and may be one or more of the measured at least one characteristic or a prediction relating to the at least one characteristic. The channel state information, in some aspects, may be based on the measurement, at 1310, of the at least one characteristic of each of the spatial-domain resources in the second set of spatial-domain resources associated with the first set of spatial-domain resources and may be a predicted value for the at least one characteristic. The predicted value, in some aspects, may be based on a ML, AI, or other analysis of the measurements made at 1310. In some aspects, the channel state information indicative of the at least one characteristic may further include an indication of one or more of the first number of spatial-domain resources in the plurality of spatial-domain resources, the second number of spatial-domain resources in the first set of spatial-domain resources, and the index associated with the first set of spatial-domain resources. For example, referring to FIG. 7, the UE 702 may transmit measurement information 718 (e.g., a CSI report) including group index 722, group report configuration 720, group index 722, reference beam ID 724, reference beam signal strength 726, and the set of beam strength difference values 728.

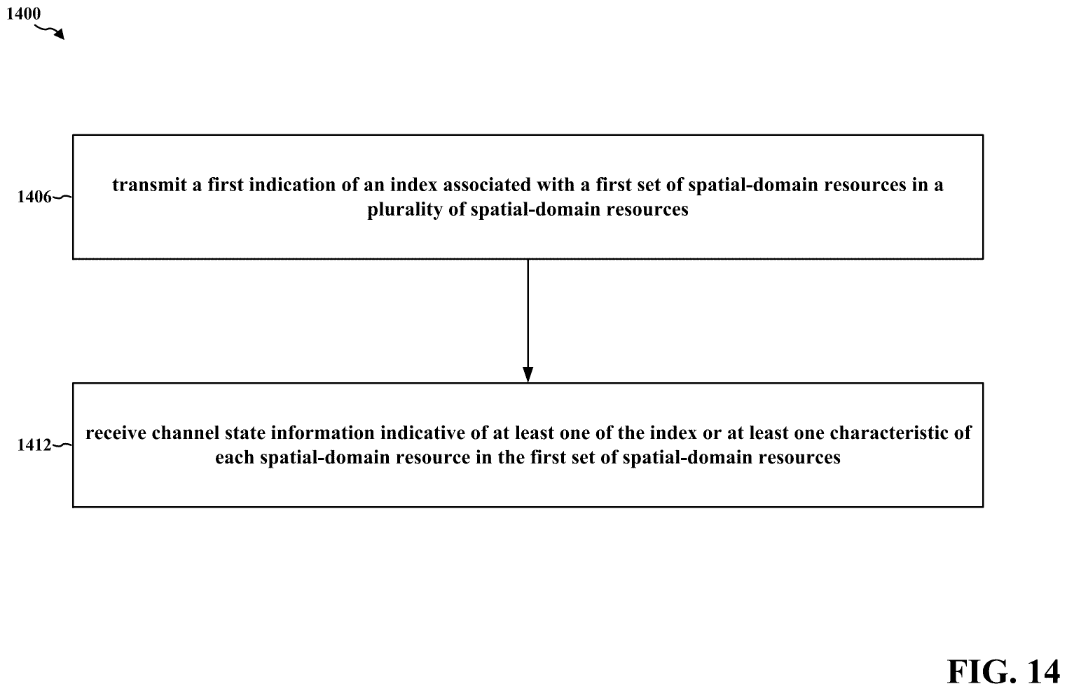

FIG. 14 is a flowchart 1400 of a method of wireless communication. The method may be performed by a base station (e.g., the base station 102, 402, or 704; the network entity 1802). The base station may transmit a second indication of a first number (e.g., N) of spatial-domain resources in a plurality of spatial-domain resources. In some aspects, the plurality of spatial-domain resources is a set of spatial-domain resources configured in a CSI measurement and/or CSI report configuration transmitted by the base station and including the second indication. The plurality of spatial-domain resources, in some aspects, may be candidate spatial-domain resources for measurement and/or reporting. For example, referring to FIGS. 4A, 4B, 4C, 5, and 7, the base station 402 or 704 may transmit beam-group-index configuration 706 from base station 704 indicating a number of resources in one of the first set of Tx resources 410, the second set of Tx resources 420, resources 610, or a set of Tx-and-Rx resource-pairs.

The base station, in some aspects, may transmit a third indication of a second number of spatial-domain resources in a first set of spatial-domain resources. In some aspects, the first set of spatial-domain resources are a set (or subset) of spatial-domain resources configured in the CSI measurement and/or CSI report configuration transmitted by the base station. The second number of spatial-domain resources, in some aspects, may reflect a number of spatial-domain resources (e.g., beams or beam-pairs) for which measurement information is requested. The second number of spatial-domain resources, in some aspects, may be used to determine a size of a variable-size payload associated with the combinatorial-based index or the bitmap-based index and/or a variable-sized payload associated with a set of measured and/or predicted signal strengths associated with the first set of spatial-domain resources. In some aspects, the second number of spatial-domain resources may be used to define a mapping (e.g., identify a particular mapping from a set of potential mappings) between a combinatorial-based index and a set of spatial-domain resources indicated by the index. For example, referring to FIG. 7, the base station 704 may receive beam measurement and/or group index indication 710 indicating a number of resources associated with a request for CSI to the UE 702.

At 1406, the base station may transmit a first indication of an index associated with a first set of spatial-domain resources in a plurality of spatial-domain resources. For example, 1406 may be performed by CU processor 1812, DU processor 1832, RU processor 1842, transceiver(s) 1846, antenna(s) 1880, and/or GBBI requesting component 199 of FIG. 18. The index, in some aspects, may be one of a combinatorial-based index or the bitmap-based index indicating the spatial-domain resources from the plurality of spatial-domain resources that are included in the first set of spatial-domain resources. In some aspects, the combinatorial-based index may include at least a third number of bits capable of representing a fourth number equal to a number of possible combinations of the second number of spatial-domain resources in the first set of spatial-domain resources selected from the first number of spatial-domain resources in the plurality of spatial-domain resources. The bitmap-based index, in some aspects, may include a number of bits equal to the first number of spatial-domain resources in the plurality of spatial-domain resources and includes a fifth number of bits indicating spatial-domain resources in the first set of spatial-domain resources, where the fifth number of bits is equal to the second number of spatial-domain resources in the first set of spatial-domain resources. For example, referring to FIGS. 6 and 7, the base station704 may transmit a combinatorial-based index or bitmap-based index in beam measurement and/or group index indication 710 indicating a set of spatial-domain resources for which to provide measurement information 718 (e.g., a CSI report) based on the bitmap-based method 640 or the combinatorial based method 650.

The base station may transmit a fourth indication that at least one characteristic to be measured and/or reported for the first set of spatial-domain resources is one or a RSRP or a SINR and a fifth indication for the UE to measure the at least one characteristic. The fourth indication, in some aspects may be included in RRC signaling or the fourth and fifth indication may be included in a MAC-CE or DCI. For example, referring to FIG. 7, the base station may transmit an indication of a type of measurement or value to include in a measurement information 718 via beam-group-index configuration 706 or beam measurement and/or group index indication 710. In some aspects, the beam measurement and/or group index indication 710 may be transmitted via a MAC-CE or DCI.

The base station may receive, at 1412, channel state information (e.g., a CSI report) indicative of at least one of the index associated with the first set of spatial-domain resources or the at least one characteristic of each spatial-domain resource in the first set of spatial-domain resources. For example, 1412 may be performed by CU processor 1812, DU processor 1832, RU processor 1842, transceiver(s) 1846, antenna(s) 1880, and/or GBBI requesting component 199 of FIG. 18. The channel state information, in some aspects, may be received based on the index transmitted at 1406 and the fourth and fifth indications. The channel state information, in some aspects, may include a first indication of the index associated with the first set of spatial-domain resources in the plurality of spatial-domain resources. The index, in some aspects, may be one of the combinatorial-based index or the bitmap-based index indicating the spatial-domain resources from the plurality of spatial-domain resources that are included in the first set of spatial-domain resources. The index, in some aspects, may be omitted when the channel state information is indicated, or known, to be associated with the index transmitted at 1406. The channel state information, in some aspects, may include channel state information indicative of at least one characteristic of each spatial-domain resource in the first set of spatial-domain resources. The channel state information indicative of the at least one characteristic, in some aspects, may be one of a measured or predicted signal strength associated with the resources in the first set of spatial-domain resources. In some aspects, the channel state information may be based on a measurement of the at least one characteristic of at least a subset of the first set of spatial-domain resources and may be one or more of the measured at least one characteristic or a prediction relating to the at least one characteristic. The channel state information, in some aspects, may be based on a measurement of the at least one characteristic of each of the spatial-domain resources in the second set of spatial-domain resources associated with the first set of spatial-domain resources and may be a predicted value for the at least one characteristic. The predicted value, in some aspects, may be based on a ML, AI, or other analysis of the measurements made by the UE. For example, referring to FIG. 7, the base station 704 may receive measurement information 718 (e.g., a CSI report) including group index 722, reference beam ID 724, reference beam signal strength 726, and the set of beam strength difference values 728.

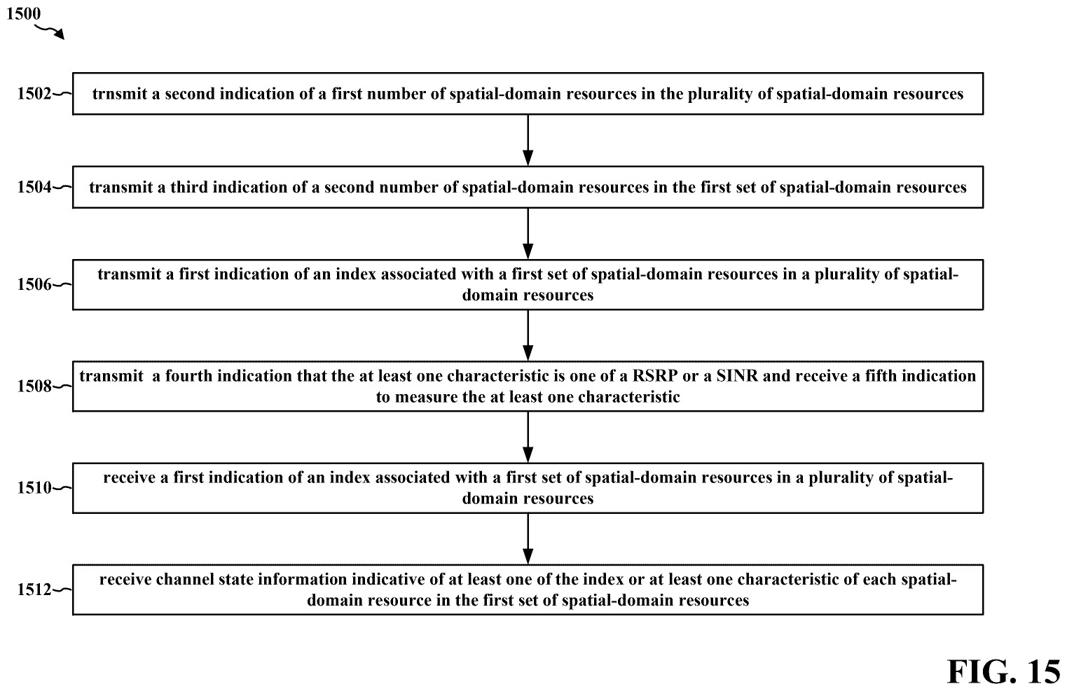

FIG. 15 is a flowchart 1500 of a method of wireless communication. The method may be performed by a base station (e.g., the base station 102, 402, or 704; the network entity 1802). At 1502, the base station may transmit a second indication of a first number (e.g., N) of spatial-domain resources in a plurality of spatial-domain resources. For example, 1502 may be performed by CU processor 1812, DU processor 1832, RU processor 1842, transceiver(s) 1846, antenna(s) 1880, and/or GBBI requesting component 199 of FIG. 18. In some aspects, the plurality of spatial-domain resources is a set of spatial-domain resources configured in a CSI measurement and/or CSI report configuration transmitted at 1502 and including the second indication. The plurality of spatial-domain resources, in some aspects, may be candidate spatial-domain resources for measurement and/or reporting. For example, referring to FIGS. 4A, 4B, 4C, 5, and 7, the base station 402 or 704 may transmit beam-group-index configuration 706 from base station 704 indicating a number of resources in one of the first set of Tx resources 410, the second set of Tx resources 420, resources 610, or a set of Tx-and-Rx resource-pairs.

At 1504, the base station may transmit a third indication of a second number of spatial-domain resources in a first set of spatial-domain resources. For example, 1504 may be performed by CU processor 1812, DU processor 1832, RU processor 1842, transceiver(s) 1846, antenna(s) 1880, and/or GBBI requesting component 199 of FIG. 18. In some aspects, the first set of spatial-domain resources are a set (or subset) of spatial-domain resources configured in the CSI measurement and/or CSI report configuration transmitted at 1502. The second number of spatial-domain resources, in some aspects, may reflect a number of spatial-domain resources (e.g., beams or beam-pairs) for which measurement information is requested. The second number of spatial-domain resources, in some aspects, may be used to determine a size of a variable-size payload associated with the combinatorial-based index or the bitmap-based index and/or a variable-sized payload associated with a set of measured and/or predicted signal strengths associated with the first set of spatial-domain resources. In some aspects, the second number of spatial-domain resources may be used to define a mapping (e.g., identify a particular mapping from a set of potential mappings) between a combinatorial-based index and a set of spatial-domain resources indicated by the index. For example, referring to FIG. 7, the base station 704 may receive beam measurement and/or group index indication 710 indicating a number of resources associated with a request for CSI to the UE 702.

At 1506, the base station may transmit a first indication of an index associated with a first set of spatial-domain resources in a plurality of spatial-domain resources. For example, 1506 may be performed by CU processor 1812, DU processor 1832, RU processor 1842, transceiver(s) 1846, antenna(s) 1880, and/or GBBI requesting component 199 of FIG. 18. The index, in some aspects, may be one of a combinatorial-based index or the bitmap-based index indicating the spatial-domain resources from the plurality of spatial-domain resources that are included in the first set of spatial-domain resources. In some aspects, the combinatorial-based index may include at least a third number of bits capable of representing a fourth number equal to a number of possible combinations of the second number of spatial-domain resources in the first set of spatial-domain resources selected from the first number of spatial-domain resources in the plurality of spatial-domain resources. The bitmap-based index, in some aspects, may include a number of bits equal to the first number of spatial-domain resources in the plurality of spatial-domain resources and includes a fifth number of bits indicating spatial-domain resources in the first set of spatial-domain resources, where the fifth number of bits is equal to the second number of spatial-domain resources in the first set of spatial-domain resources. For example, referring to FIGS. 6 and 7, the base station704 may transmit a combinatorial-based index or bitmap-based index in beam measurement and/or group index indication 710 indicating a set of spatial-domain resources for which to provide measurement information 718 (e.g., a CSI report) based on the bitmap-based method 640 or the combinatorial based method 650.

At 1508, the base station may transmit a fourth indication that at least one characteristic to be measured and/or reported for the first set of spatial-domain resources is one or a RSRP or a SINR and a fifth indication for the UE to measure the at least one characteristic. For example, 1508 may be performed by CU processor 1812, DU processor 1832, RU processor 1842, transceiver(s) 1846, antenna(s) 1880, and/or GBBI requesting component 199 of FIG. 18. The fourth indication, in some aspects may be included in RRC signaling or the fourth and fifth indication may be included in a MAC-CE or DCI. For example, referring to FIG. 7, the base station may transmit an indication of a type of measurement or value to include in a measurement information 718 via beam-group-index configuration 706 or beam measurement and/or group index indication 710. In some aspects, the beam measurement and/or group index indication 710 may be transmitted via a MAC-CE or DCI.

At 1510, the base station may receive a first indication of an index associated with a first set of spatial-domain resources in a plurality of spatial-domain resources. For example, 1510 may be performed by CU processor 1812, DU processor 1832, RU processor 1842, transceiver(s) 1846, antenna(s) 1880, and/or GBBI requesting component 199 of FIG. 18. The index, in some aspects, may be one of the combinatorial-based index or the bitmap-based index indicating the spatial-domain resources from the plurality of spatial-domain resources that are included in the first set of spatial-domain resources. For example, referring to FIG. 7, the base station 704 may receive measurement information 718 (e.g., a CSI report) including group index 722 indicating the selected resources (e.g., the resources for which values are reported in the measurement information 718). The index, in some aspects, may be omitted when the channel state information is indicated, or known, to be associated with the index transmitted at 1406.

Finally, at 1512, the base station may receive channel state information (e.g., a CSI report) indicative of at least one of the index associated with the first set of spatial-domain resources or at least one characteristic of each spatial-domain resource in the first set of spatial-domain resources. For example, 1512 may be performed by CU processor 1812, DU processor 1832, RU processor 1842, transceiver(s) 1846, antenna(s) 1880, and/or GBBI requesting component 199 of FIG. 18. The channel state information indicative of the at least one characteristic, in some aspects, may be one of a measured or predicted signal strength associated with the resources in the first set of spatial-domain resources. In some aspects, the channel state information may be based on a measurement of the at least one characteristic of at least a subset of the first set of spatial-domain resources and may be one or more of the measured at least one characteristic or a prediction relating to the at least one characteristic. The channel state information, in some aspects, may be based on a measurement of the at least one characteristic of each of the spatial-domain resources in the second set of spatial-domain resources associated with the first set of spatial-domain resources and may be a predicted value for the at least one characteristic. The predicted value, in some aspects, may be based on a ML, AI, or other analysis of the measurements made by the UE. For example, referring to FIG. 7, the base station 704 may receive measurement information 718 (e.g., a CSI report) including group index 722, reference beam ID 724, reference beam signal strength 726, and the set of beam strength difference values 728.

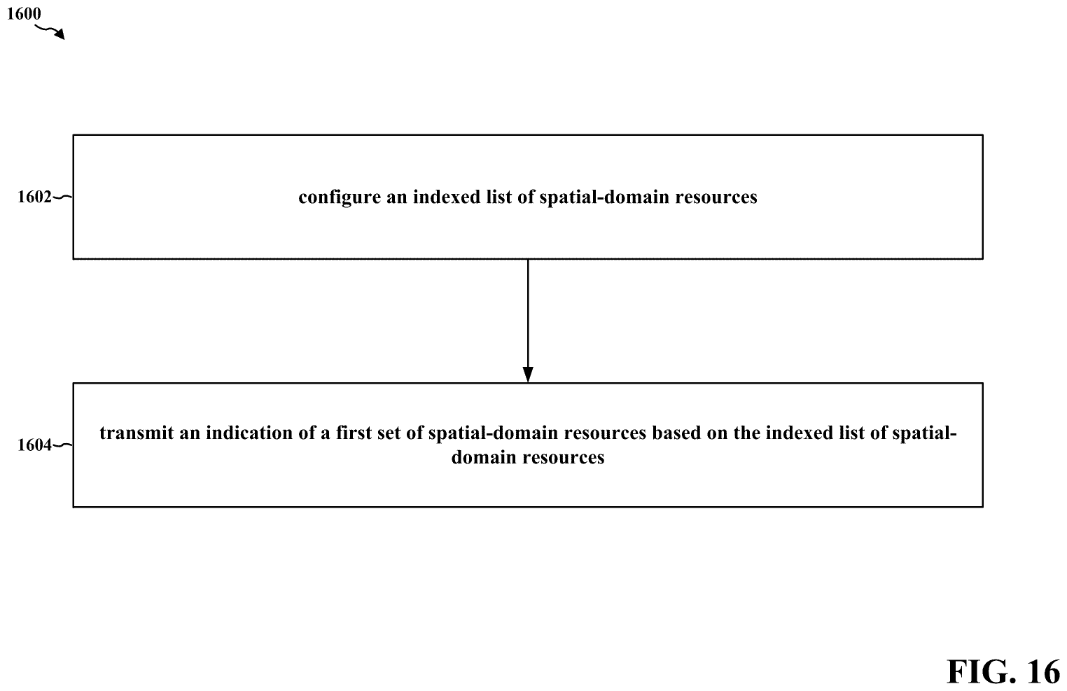

FIG. 16 is a flowchart 1600 of a method of wireless communication. The method may be performed by a wireless device, e.g., a UE (e.g., the UE 104, 404, or 702; the apparatus 1704) or a base station (e.g., the base station 102, 402, or 704; the network entity 1802). At 1602, the wireless device may configure an indexed list of spatial-domain resources. For example, 1602 may be performed by application processor 1706, cellular baseband processor 1724, and/or GBBI reporting component 198 of FIG. 17 or may be performed by CU processor 1812, DU processor 1832, RU processor 1842, and/or GBBI requesting component 199 of FIG. 18. In some aspects, the spatial-domain resources (e.g., beams) in the indexed list of spatial-domain resources may be spatial-domain resources (e.g., Tx beams) for transmission from a transmitting device and an order of the spatial-domain resources in the indexed list of spatial-domain resources is based on at least a first identifier of each domain resources for transmission from the transmitting device. For example, referring to FIG. 5, the wireless device may configure a beam ordering in accordance with beam-pair ordering 511 or 512.

The spatial-domain resources in the indexed list of spatial-domain resources, in some aspects, may be spatial-domain resource pairs (e.g., beam-pairs). Each spatial-domain resource pair, in some aspects, includes a spatial-domain resource (or beam) in a first set of spatial-domain resources (e.g., Tx beams) for transmission from the transmitting device and a corresponding spatial-domain resource (beams) in a second set of spatial domain resources (e.g., UE Rx beams) for reception at a receiving device. The order of the spatial-domain resource pairs (e.g., beam-pairs) in the indexed list of spatial-domain resources, in some aspects, may be based on an identifier of the spatial-domain resource for transmission from the transmitting device (e.g., a CMR ID, IMR ID, or SSBRI) and an identifier of the spatial-domain resource for reception at the receiving device (e.g., a UE Rx beam ID) for each spatial-domain resource pair in the indexed list of spatial-domain resources.

In some aspects, the order of the spatial-domain resources in the indexed list of spatial-domain resources may be based on an ascending order based firstly on a value for the identifier of the spatial-domain resource in the first set of spatial-domain resources for transmission from the transmitting device (e.g., a CMR ID, IMR ID, or SSBRI). The order of the spatial-domain resources in the indexed list of spatial-domain resources may secondly be based on a value of the identifier of the spatial-domain resource in the second set of spatial-domain resources for reception at a receiving device. In some such aspects, a first spatial-domain resource pair in the indexed list of spatial-domain resources may be a spatial-domain resource pair associated with a lowest value for the identifier of the spatial-domain resource in the first set of spatial-domain resources and a lowest value of the identifier for the spatial-domain resource in the second set of spatial-domain resources. Similarly, a last spatial-domain resource pair in the indexed list of spatial-domain resources may be a spatial-domain resource pair associated with a highest value for the identifier of the spatial-domain resource in the first set of spatial-domain resources and a highest value of the identifier for the spatial-domain resource in the second set of spatial-domain resources. For example, referring to FIG. 5, the wireless device may configure a beam-pair ordering in accordance with beam-pair ordering 521.

In some aspects, the order of the spatial-domain resources in the indexed list of spatial-domain resources may be based on a descending order based firstly on a value for the identifier of the spatial-domain resource in the first set of spatial-domain resources for transmission from the transmitting device and secondly on a value of the identifier of the spatial-domain resource in the second set of spatial-domain resources for reception at a receiving device. In some such aspects, a first spatial-domain resource pair in the indexed list of spatial-domain resources may be a spatial-domain resource associated with a highest value of the identifier of the spatial-domain resource in the first set of spatial-domain resources and a highest value of the identifier of the spatial-domain resource in the second set of spatial-domain resources. Similarly, a last spatial-domain resource pair in the indexed list of spatial-domain resources may be a spatial-domain resource associated with a lowest value for the identifier of the spatial-domain resource in the first set of spatial-domain resources and a lowest value of the identifier of the spatial-domain resource in the second set of spatial-domain resources. For example, referring to FIG. 5, the wireless device may configure a beam-pair ordering in accordance with beam-pair ordering 522.

In some aspects, the order of the spatial-domain resources in the indexed list of spatial-domain resources may be based on an ascending order based firstly on a value for the identifier of the spatial-domain resource in the second set of spatial-domain resources for reception at a receiving device and secondly on a value of the identifier of the spatial-domain resource in the first set of spatial-domain resources for transmission from the transmitting device. In some such aspects, a first spatial-domain resource pair in the indexed list of spatial-domain resources may be a spatial-domain resource associated with a lowest value for the identifier of the spatial-domain resource in the second set of spatial-domain resources and a lowest value of the identifier for the spatial-domain resource in the first set of spatial-domain resources. Similarly, a last spatial-domain resource pair in the indexed list of spatial-domain resources may be a spatial-domain resource associated with a highest value for the identifier of the spatial-domain resource in the second set of spatial-domain resources and a highest value of the identifier for the spatial-domain resource in the first set of spatial-domain resources.

In some aspects, the order of the spatial-domain resources in the indexed list of spatial-domain resources may be based on a descending order based firstly on a value for the identifier of the spatial-domain resource in the second set of spatial-domain resources for reception at a receiving device and secondly on a value of the identifier of the spatial-domain resource in the first set of spatial-domain resources for transmission from the transmitting device In some such aspects, a first spatial-domain resource pair in the indexed list of spatial-domain resources may be a spatial-domain resource associated with a highest value of the identifier of the spatial-domain resource in the second set of spatial-domain resources and a highest value of the identifier of the spatial-domain resource in the first set of spatial-domain resources. Similarly, a last spatial-domain resource pair in the indexed list of spatial-domain resources may be a spatial-domain resource associated with a lowest value for the identifier of the spatial-domain resource in the second set of spatial-domain resources and a lowest value of the identifier of the spatial-domain resource in the first set of spatial-domain resources. For example, referring to FIG. 5, the wireless device may configure a beam-pair ordering in accordance with beam-pair ordering 524. At 1604, the wireless device may transmit an indication of a first set of spatial-domain resources based on the indexed list of spatial-domain resources. For example, 1604 may be performed by application processor 1706, cellular baseband processor 1724, transceiver(s) 1722, antenna(s) 1780, and/or GBBI reporting component 198 of FIG. 17 or may be performed by CU processor 1812, DU processor 1832, RU processor 1842, transceiver(s) 1846, antenna(s) 1880, and/or GBBI requesting component 199 of FIG. 18. The indication of the first set of spatial-domain resources based on the indexed list of spatial-domain resources, in some aspects, may be one of a combinatorial-based index or a bitmap-based index that identifies elements in the ordered and/or indexed list. For example, referring to FIG. 6, the resources 610 may be ordered based on the indexed list and the bitmap-based method 640 and/or the combinatorial based method 650 may identify the selected resources 620 by identifying locations and/or indexes into the ordered and/or indexed list of resources without providing unique identifiers of the selected resources 620. Referring to FIG. 7, for example, the base station 704 may transmit a beam measurement and/or group index indication 710 including a combinatorial-based index or a bitmap-based index that identifies elements in the ordered and/or indexed list or the UE 702 may transmit measurement information 718 including a group index 722 using a combinatorial-based index or a bitmap-based index based on, or referring to, the ordered and/or indexed list of resources.

FIG. 17 is a diagram 1700 illustrating an example of a hardware implementation for an apparatus 1704. The apparatus 1704 may be a UE, a component of a UE, or may implement UE functionality. In some aspects, the apparatus 1704 may include a cellular baseband processor 1724 (also referred to as a modem) coupled to one or more transceivers 1722 (e.g., cellular RF transceiver). The cellular baseband processor 1724 may include on-chip memory 1724′. In some aspects, the apparatus 1704 may further include one or more subscriber identity modules (SIM) cards 1720 and an application processor 1706 coupled to a secure digital (SD) card 1708 and a screen 1710. The application processor 1706 may include on-chip memory 1706′. In some aspects, the apparatus 1704 may further include a Bluetooth module 1712, a WLAN module 1714, an SPS module 1716 (e.g., GNSS module), one or more sensor modules 1718 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1726, a power supply 1730, and/or a camera 1732. The Bluetooth module 1712, the WLAN module 1714, and the SPS module 1716 may include an on-chip transceiver (TRX) (or in some cases, just a receiver (RX)). The Bluetooth module 1712, the WLAN module 1714, and the SPS module 1716 may include their own dedicated antennas and/or utilize the antennas 1780 for communication. The cellular baseband processor 1724 communicates through the transceiver(s) 1722 via one or more antennas 1780 with the UE 104 and/or with an RU associated with a network entity 1702. The cellular baseband processor 1724 and the application processor 1706 may each include a computer-readable medium/memory 1724′, 1706′, respectively. The additional memory modules 1726 may also be considered a computer-readable medium/memory. Each computer-readable medium/memory 1724′, 1706′, 1726 may be non-transitory. The cellular baseband processor 1724 and the application processor 1706 are each responsible for general processing, including the execution of software stored on the computer-readable medium/memory. The software, when executed by the cellular baseband processor 1724/application processor 1706, causes the cellular baseband processor 1724/application processor 1706 to perform the various functions described supra. The computer-readable medium/memory may also be used for storing data that is manipulated by the cellular baseband processor 1724/application processor 1706 when executing software. The cellular baseband processor 1724/application processor 1706 may be a component of the UE 350 and may include the memory 360 and/or at least one of the TX processor 368, the RX processor 356, and the controller/processor 359. In one configuration, the apparatus 1704 may be a processor chip (modem and/or application) and include just the cellular baseband processor 1724 and/or the application processor 1706, and in another configuration, the apparatus 1704 may be the entire UE (e.g., see 350 of FIG. 3) and include the additional modules of the apparatus 1704.

As discussed supra, the GBBI reporting component 198 is configured to transmit a first indication of an index associated with a first set of spatial-domain resources in a plurality of spatial-domain resources and transmit or receive channel state information indicative of at least one of the index associated with the first set of spatial-domain resources or at least one characteristic of each spatial-domain resource in the first set of spatial-domain resources. The GBBI reporting component 198, in some aspects, may be configured to receive a first indication of an index associated with a first set of spatial-domain resources in a plurality of spatial-domain resources and transmit or receive channel state information indicative of at least one of the index associated with the first set of spatial-domain resources or at least one characteristic of each spatial-domain resource in the first set of spatial-domain resources. The GBBI reporting component 198 may be within the cellular baseband processor 1724, the application processor 1706, or both the cellular baseband processor 1724 and the application processor 1706. The GBBI reporting component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1704 may include a variety of components configured for various functions. In one configuration, the apparatus 1704, and in particular the cellular baseband processor 1724 and/or the application processor 1706, includes means for transmitting a first indication of an index associated with a first set of spatial-domain resources in a plurality of spatial-domain resources. The apparatus 1704, and in particular the cellular baseband processor 1724 and/or the application processor 1706, may further include means for transmitting channel state information indicative of at least one of the index associated with the first set of spatial-domain resources or at least one characteristic of each spatial-domain resource in the first set of spatial-domain resources. The apparatus 1704, and in particular the cellular baseband processor 1724 and/or the application processor 1706, may further include means for measuring the at least one characteristic of at least a subset of the first set of spatial-domain resources. The apparatus 1704, and in particular the cellular baseband processor 1724 and/or the application processor 1706, may further include means for measuring the at least one characteristic of each spatial-domain resource in a second set of spatial-domain resources associated with the first set of spatial-domain resources. The apparatus 1704, and in particular the cellular baseband processor 1724 and/or the application processor 1706, may further include means for receiving a second indication of a first number of spatial-domain resources in the plurality of spatial-domain resources. The apparatus 1704, and in particular the cellular baseband processor 1724 and/or the application processor 1706, may further include means for receiving a third indication of a second number of spatial-domain resources in the first set of spatial-domain resources. The apparatus 1704, and in particular the cellular baseband processor 1724 and/or the application processor 1706, may further include means for transmitting, based on the first number of spatial-domain resources in the plurality of spatial-domain resources and the second number of spatial-domain resources in the first set of spatial-domain resources, a sixth indication that the index is one of the combinatorial-based index or the bitmap-based index instead of a set of identifiers for identifying spatial-domain resources in the first set of spatial-domain resources. The apparatus 1704, and in particular the cellular baseband processor 1724 and/or the application processor 1706, may further include means for receiving, based on the first number of spatial-domain resources in the plurality of spatial-domain resources and the second number of spatial-domain resources in the first set of spatial-domain resources, a sixth indication that the index is one of the combinatorial-based index or the bitmap-based index instead of a set of identifiers for identifying spatial-domain resources in the first set of spatial-domain resources. The apparatus 1704, and in particular the cellular baseband processor 1724 and/or the application processor 1706, may further include means for transmitting a third indication of a second number of spatial-domain resources in the first set of spatial-domain resources, where the first indication of the index associated with the first set of spatial-domain resources is based on the third indication. The apparatus 1704, and in particular the cellular baseband processor 1724 and/or the application processor 1706, may further include means for receiving a first indication of an index associated with a first set of spatial-domain resources in a plurality of spatial-domain resources. The apparatus 1704, and in particular the cellular baseband processor 1724 and/or the application processor 1706, may further include means for receiving a fourth indication that the at least one characteristic is one of a RSRP or a SINR. The apparatus 1704, and in particular the cellular baseband processor 1724 and/or the application processor 1706, may further include means for receiving a fifth indication for a second wireless device from which the channel state information is received to measure the at least one characteristic. The apparatus 1704, and in particular the cellular baseband processor 1724 and/or the application processor 1706, may further include means for transmitting a second indication of a first number of spatial-domain resources in the plurality of spatial-domain resources. The apparatus 1704, and in particular the cellular baseband processor 1724 and/or the application processor 1706, may further include means for transmitting a third indication of a second number of spatial-domain resources in the first set of spatial-domain resources. The apparatus 1704, and in particular the cellular baseband processor 1724 and/or the application processor 1706, may further include means for transmitting a set of measured or predicted values associated with the at least one characteristic for each of the spatial-domain resources in the first set of spatial-domain resources. The apparatus 1704, and in particular the cellular baseband processor 1724 and/or the application processor 1706, may further include means for receiving a fourth indication of a number of spatial-domain resources in the plurality of spatial-domain resources, where the fourth indication is included in a configuration setting associated with measuring the at least one characteristic. The apparatus 1704, and in particular the cellular baseband processor 1724 and/or the application processor 1706, may further include means for receiving a fifth indication of a second number of spatial-domain resources in the first set of spatial-domain resources. The means may be the GBBI reporting component 198 of the apparatus 1704 configured to perform the functions recited by the means or any of the functions describe in relation to FIG. 7-9, 12, 13, or 16. As described supra, the apparatus 1704 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 18 is a diagram 1800 illustrating an example of a hardware implementation for a network entity 1802. The network entity 1802 may be a BS, a component of a BS, or may implement BS functionality. The network entity 1802 may include at least one of a CU 1810, a DU 1830, or an RU 1840. For example, depending on the layer functionality handled by the GBBI requesting component 199, the network entity 1802 may include the CU 1810; both the CU 1810 and the DU 1830; each of the CU 1810, the DU 1830, and the RU 1840; the DU 1830; both the DU 1830 and the RU 1840; or the RU 1840. The CU 1810 may include a CU processor 1812. The CU processor 1812 may include on-chip memory 1812′. In some aspects, the CU 1810 may further include additional memory modules 1814 and a communications interface 1818. The CU 1810 communicates with the DU 1830 through a midhaul link, such as an F1 interface. The DU 1830 may include a DU processor 1832. The DU processor 1832 may include on-chip memory 1832′. In some aspects, the DU 1830 may further include additional memory modules 1834 and a communications interface 1838. The DU 1830 communicates with the RU 1840 through a fronthaul link. The RU 1840 may include an RU processor 1842. The RU processor 1842 may include on-chip memory 1842′. In some aspects, the RU 1840 may further include additional memory modules 1844, one or more transceivers 1846, antennas 1880, and a communications interface 1848. The RU 1840 communicates with the UE 104. The on-chip memory 1812′, 1832′, 1842′ and the additional memory modules 1814, 1834, 1844 may each be considered a computer-readable medium/memory. Each computer-readable medium/memory may be non-transitory. Each of the processors 1812, 1832, 1842 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the GBBI requesting component 199 is configured to transmit a first indication of an index associated with a first set of spatial-domain resources in a plurality of spatial-domain resources and receive channel state information indicative of at least one of the index associated with the first set of spatial-domain resources or at least one characteristic of each spatial-domain resource in the first set of spatial-domain resources. In some aspect, the GBBI requesting component 199 may be configured to receive a first indication of an index associated with a first set of spatial-domain resources in a plurality of spatial-domain resources and receive channel state information indicative of at least one of the index associated with the first set of spatial-domain resources or at least one characteristic of each spatial-domain resource in the first set of spatial-domain resources. The GBBI requesting component 199 may be within one or more processors of one or more of the CU 1810, DU 1830, and the RU 1840. The GBBI requesting component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1802 may include a variety of components configured for various functions. In one configuration, the network entity 1802 includes means for receiving a first indication of an index associated with a first set of spatial-domain resources in a plurality of spatial-domain resources. In some aspects, the network entity 1802 may further include means for transmitting a first indication of an index associated with a first set of spatial-domain resources in a plurality of spatial-domain resources. In some aspects, the network entity 1802 may further include means for receiving channel state information indicative of at least one of the index associated with the first set of spatial-domain resources or at least one characteristic of each spatial-domain resource in the first set of spatial-domain resources. In some aspects, the network entity 1802 may further include means for receiving a set of measured or predicted values associated with the at least one characteristic for each of the spatial-domain resources in the first set of spatial-domain resources. In some aspects, the network entity 1802 may further include means for transmitting a fourth indication of a number of spatial-domain resources in the plurality of spatial-domain resources. In some aspects, the network entity 1802 may further include means for transmitting a fifth indication of a second number of spatial-domain resources in the first set of spatial-domain resources. In some aspects, the network entity 1802 may further include means for transmitting a second indication of a first number of spatial-domain resources in the plurality of spatial-domain resources. In some aspects, the network entity 1802 may further include means for transmitting a third indication of a second number of spatial-domain resources in the first set of spatial-domain resources. In some aspects, the network entity 1802 may further include means for transmitting, based on the first number of spatial-domain resources in the plurality of spatial-domain resources and the second number of spatial-domain resources in the first set of spatial-domain resources, a sixth indication that the index is one of the combinatorial-based index or the bitmap-based index instead of a set of identifiers for identifying spatial-domain resources in the first set of spatial-domain resources. In some aspects, the network entity 1802 may further include means for transmitting a second indication of a first number of spatial-domain resources in the plurality of spatial-domain resources. In some aspects, the network entity 1802 may further include means for receiving a third indication of a second number of spatial-domain resources in the first set of spatial-domain resources. In some aspects, the network entity 1802 may further include means for transmitting a fourth indication that the at least one characteristic is one of a RSRP or a SINR. In some aspects, the network entity 1802 may further include means for transmitting a fifth indication for a second wireless device to measure the at least one characteristic. The means may be the GBBI requesting component 199 of the network entity 1802 configured to perform the functions recited by the means or any of the functions describe in relation to FIG. 7, 10, 11, or 14-16. As described supra, the network entity 1802 may include the TX processor 316, the RX processor 370, and the controller/processor 375. As such, in one configuration, the means may be the TX processor 316, the RX processor 370, and/or the controller/processor 375 configured to perform the functions recited by the means.

In some aspects of wireless communication, e.g., 5G NR, one or more beam management operations are performed to measure and/or predict channel quality, e.g., for a CSI report. The CSI report, in some aspects, includes an identification of a set of beams (e.g., spatial domain resources and/or temporal domain resources) associated with beamforming a set of transmissions (e.g., RS transmissions during a measuring operation and subsequent data transmissions) from a transmitting device. The identified beams may include beams associated with a measurement and/or prediction by the reporting device. Although currently a number of beams selected for measurement and/or reporting, in some aspects, may be small (e.g., 1, 2, or 4), the selection of larger numbers of beams selected for measurement and/or reporting may be used in future implementations. For reports associated with a large number (e.g., 8 or more) of measured and/or predicted beams selected from an even larger number of candidate beams for measurement and/or prediction (e.g., 16 or more), identifying the measured and/or predicted beams may consume a large number of signaling resources (e.g., may introduce a large overhead). Accordingly, the method and apparatus described above are provided to reduce an overhead associated with identifying a set of beams (e.g., CSI resources) for measurement and/or reporting compared to a naïve extension of a current method and apparatus sending a list of beam IDs such as CMR IDs, IMR IDs, or SSBRI.

The method and apparatus may use a combinatorial index and/or a bitmap (sometimes referred to as a combinatorial-based index or a bitmap-based index, respectively) to signal and/or identify a set of beams for measurement and/or reporting. The combinatorial index and/or the bitmap may, in some aspects, to a known, or configured, ordering of candidate beams and or beam pairs (e.g., combinations of a first resource or beam for transmitting a signal from the transmitting device and a second resource or beam for receiving the signal at a receiving device) provided by the method and apparatus.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a wireless device, including transmitting a first indication of an index associated with a first set of spatial-domain resources in a plurality of spatial-domain resources and transmitting or receiving channel state information indicative of at least one of the index associated with the first set of spatial-domain resources or at least one characteristic of each spatial-domain resource in the first set of spatial-domain resources.

Aspect 2 is the method of aspect 1, where the wireless device is a UE, the method further including measuring the at least one characteristic of at least a subset of the first set of spatial-domain resources, where the channel state information indicative of the at least one characteristic is based on the measured at least one characteristic and is one or more of the measured at least one characteristic or a prediction relating to the at least one characteristic.

Aspect 3 is the method of aspect 1, where the wireless device is a UE, the method further including measuring the at least one characteristic of each spatial-domain resource in a second set of spatial-domain resources associated with the first set of spatial-domain resources, where the channel state information indicative of the at least one characteristic of each of the spatial-domain resources in the first set of spatial-domain resources is based on the measured at least one characteristic of each of the spatial-domain resources in the second set of spatial-domain resources and is a predicted value for the at least one characteristic.

Aspect 4 is the method of any of aspects 1 to 3, where the wireless device is a UE, the method further including receiving a second indication of a first number of spatial-domain resources in the plurality of spatial-domain resources.

Aspect 5 is the method of aspect 4, further including receiving a third indication of a second number of spatial-domain resources in the first set of spatial-domain resources.

Aspect 6 is the method of any of aspects 4 or 5, where the first set of spatial-domain resources includes a second number of spatial-domain resources and the index associated with the first set of spatial-domain resources is one of a combinatorial-based index or a bitmap-based index, where the combinatorial-based index includes at least a third number of bits capable of representing a fourth number equal to a number of possible combinations of the second number of spatial-domain resources in the first set of spatial-domain resources selected from the first number of spatial-domain resources in the plurality of spatial-domain resources, and where the bitmap-based index includes a number of bits equal to the first number of spatial-domain resources in the plurality of spatial-domain resources and includes a fifth number of bits indicating spatial-domain resources in the first set of spatial-domain resources, where the fifth number of bits is equal to the second number of spatial-domain resources in the first set of spatial-domain resources.

Aspect 7 is the method of aspect 6, further including transmitting, based on the first number of spatial-domain resources in the plurality of spatial-domain resources and the second number of spatial-domain resources in the first set of spatial-domain resources, a sixth indication that the index is one of the combinatorial-based index or the bitmap-based index instead of a set of identifiers for identifying spatial-domain resources in the first set of spatial-domain resources.

Aspect 8 is the method of aspect 4, further including transmitting a third indication of a second number of spatial-domain resources in the first set of spatial-domain resources, where the first indication of the index associated with the first set of spatial-domain resources is based on the third indication.

Aspect 9 is the method of aspect 8, where the first indication, the third indication, and the channel state information indicative of the at least one characteristic of each of the spatial-domain resources in the first set of spatial-domain resources are included in a variable-sized report payload, where the third indication is included in a first, fixed-size part of the variable-sized report payload and the first indication is included in a second, variable-sized part of the variable-sized report payload, where a size of the second, variable-sized part of the variable-sized report payload is based on the first number of spatial-domain resources indicated in the second indication and the second number of spatial-domain resources indicated in the third indication.

Aspect 10 is a method of any of aspects 1-9, where the at least one characteristic is a measure of signal strength associated with each of the spatial-domain resources in the first set of spatial-domain resources, where the channel state information indicative of the at least one characteristic of each of the spatial-domain resources in the first set of spatial-domain resources includes a fourth indication of a first spatial-domain resource having a highest measured signal strength and a fifth indication of the highest measured signal strength.

Aspect 11 is a method of aspect 10, where the channel state information indicative of the at least one characteristic of each of the spatial-domain resources in the first set of spatial-domain resources further includes a set of indications of differences between the highest measured signal strength and a measured signal strength for a corresponding set of spatial-domain resources in the first set of spatial-domain resources that does not include the first spatial-domain resource, where the corresponding set of spatial-domain resources is ordered based on one of a known or configured ordering.

Aspect 12 is a method of aspect 11, where spatial-domain resources in the plurality of spatial-domain resources and in the first set of spatial-domain resources are beams for transmission from a transmitting device, and the known or configured ordering is based on identifiers of the beams in the plurality of spatial-domain resources.

Aspect 13 is a method of aspect 11, where spatial-domain resources in the plurality of spatial-domain resources and the first set of spatial-domain resources are beam-pairs, where each beam-pair includes a first beam for transmission from a transmitting device and a corresponding second beam for reception at a receiving device, and the known or configured ordering is based on identifiers of the first beams for transmission from the transmitting device and identifiers of the second beams for reception at the receiving device.

Aspect 14 is a method of aspect 1, where the wireless device is one of a base station, a network entity, or a network node, where the first indication is transmitted via one of a MAC-CE or DCI, the method further including transmitting a fourth indication that the at least one characteristic is one of a RSRP or a SINR and transmitting a fifth indication for a second wireless device to measure the at least one characteristic, where the channel state information is received from the second wireless device.

Aspect 15 is a method of aspect 14, where the channel state information comprises a set of measured or predicted values associated with one of the RSRP or the SINR for each of the spatial-domain resources in the first set of spatial-domain resources.

Aspect 16 is a method of any of aspects 14 or 15, further including transmitting a seventh indication of a number of spatial-domain resources in the plurality of spatial-domain resources, where the fourth indication is included in a configuration setting associated with measuring the at least one characteristic.

Aspect 17 is a method of aspect 16, further including transmitting an eighth indication of a second number of spatial-domain resources in the first set of spatial-domain resources, where the first indication of the index associated with the first set of spatial-domain resources is based on the fourth indication and the fifth indication.

Aspect 18 is a method of wireless communication at a wireless device, including receiving a first indication of an index associated with a first set of spatial-domain resources in a plurality of spatial-domain resources and receiving or transmitting channel state information indicative of at least one of the index associated with the first set of spatial-domain resources or at least one characteristic of each spatial-domain resource in the first set of spatial-domain resources.

Aspect 19 is the method of aspect 18, further including transmitting a second indication of a first number of spatial-domain resources in the plurality of spatial-domain resources and transmitting a third indication of a second number of spatial-domain resources in the first set of spatial-domain resources, where the index associated with the first set of spatial-domain resources is one of a combinatorial-based index or a bitmap-based index, where the combinatorial-based index includes at least a third number of bits capable of representing a fourth number equal to a number of possible combinations of the second number of spatial-domain resources in the first set of spatial-domain resources selected from the first number of spatial-domain resources in the plurality of spatial-domain resources, and where the bitmap-based index includes a number of bits equal to the first number of spatial-domain resources in the plurality of spatial-domain resources and includes a fifth number of bits indicating spatial-domain resources in the first set of spatial-domain resources, where the fifth number of bits is equal to the second number of spatial-domain resources in the first set of spatial-domain resources.

Aspect 20 is the method of aspect 19, further including receiving, based on the first number of spatial-domain resources in the plurality of spatial-domain resources and the second number of spatial-domain resources in the first set of spatial-domain resources, a sixth indication that the index is one of the combinatorial-based index or the bitmap-based index instead of a set of identifiers for identifying spatial-domain resources in the first set of spatial-domain resources.

Aspect 21 is the method of aspect 18, further including transmitting a second indication of a first number of spatial-domain resources in the plurality of spatial-domain resources and receiving a third indication of a second number of spatial-domain resources in the first set of spatial-domain resources, where the first indication of the index associated with the first set of spatial-domain resources is based on the third indication.

Aspect 22 is the method of aspect 18, where the wireless device is a UE, where the first indication is received via one of a MAC-CE or DCI, the method further including receiving a fourth indication that the at least one characteristic is one of a RSRP or a SINR and receiving a fifth indication for the UE to measure the at least one characteristic.

Aspect 23 is the method of aspect 22, further including measuring, based on the fifth indication, at least one of the RSRP or the SINR associated with at least a subset of the first set of spatial-domain resources, where the channel state information indicative of the at least one characteristic is based on the measured at least one of the RSRP or the SINR and is one or more of the measured at least one of the RSRP or the SINR or a predicted value for at least one of the RSRP or the SINR.

Aspect 24 is the method of aspect 22, further including measure, based on the fifth indication, at least one of the RSRP or the SINR associated with each spatial-domain resource in a second set of spatial-domain resources associated with the first set of spatial-domain resources, where the channel state information indicative of the at least one characteristic of each of the spatial-domain resources in the first set of spatial-domain resources is based on the measured at least one of the RSRP or the SINR associated with each of the spatial-domain resources in the second set of spatial-domain resources and is a predicted value for at least one of the RSRP or the SINR.

Aspect 25 is the method of any of aspects 22-24, where the channel state information comprises a set of measured or predicted values associated with one of the RSRP or the SINR for each of the spatial-domain resources in the first set of spatial-domain resources.

Aspect 26 is the method of any of aspects 22-24, further including receiving a fourth indication of a number of spatial-domain resources in the plurality of spatial-domain resources, where the fourth indication is included in a configuration setting associated with measuring the at least one characteristic.

Aspect 27 is the method of aspect 26, further including receiving a fifth indication of a second number of spatial-domain resources in the first set of spatial-domain resources, where the first indication of the index associated with the first set of spatial-domain resources is based on the fourth indication and the fifth indication.

Aspect 28 is an apparatus for wireless communication at a device including a memory and at least one processor coupled to the memory and, based at least in part on information stored in the memory, the at least one processor is configured to implement any of aspects 1 to 27.

Aspect 29 is the method of aspect 28, further including a transceiver or an antenna coupled to the at least one processor.

Aspect 30 is an apparatus for wireless communication at a device including means for implementing any of aspects 1 to 27.

Aspect 31 is a computer-readable medium (e.g., a non-transitory computer-readable medium) storing computer executable code, where the code when executed by a processor causes the processor to implement any of aspects 1 to 27.

1. An apparatus for wireless communication at a wireless device, comprising:
a memory; and
at least one processor coupled to the memory and, based at least in part on first information stored in the memory, the at least one processor is configured to:
transmit a first indication of an index associated with a first set of spatial-domain resources in a plurality of spatial-domain resources; and
transmit or receive channel state information indicative of at least one of the index associated with the first set of spatial-domain resources or at least one characteristic of each spatial-domain resource in the first set of spatial-domain resources.

2. The apparatus of claim 1, wherein the wireless device is a user equipment (UE), wherein the at least one processor is further configured to:
measure the at least one characteristic of at least a subset of the first set of spatial-domain resources, wherein the channel state information indicative of the at least one characteristic is based on the measured at least one characteristic and is one or more of the measured at least one characteristic or a prediction relating to the at least one characteristic.

3. The apparatus of claim 1, wherein the wireless device is a user equipment (UE), wherein the at least one processor is further configured to:
measure the at least one characteristic of each spatial-domain resource in a second set of spatial-domain resources associated with the first set of spatial-domain resources, wherein the channel state information indicative of the at least one characteristic of each of the spatial-domain resources in the first set of spatial-domain resources is based on the measured at least one characteristic of each of the spatial-domain resources in the second set of spatial-domain resources and is a predicted value for the at least one characteristic.

4. The apparatus of claim 1, wherein the wireless device is a user equipment (UE), wherein the at least one processor is further configured to:
receive a second indication of a first number of spatial-domain resources in the plurality of spatial-domain resources.

5. The apparatus of claim 4, wherein the at least one processor is further configured to:
receive a third indication of a second number of spatial-domain resources in the first set of spatial-domain resources.

6. The apparatus of claim 4, wherein the first set of spatial-domain resources comprises a second number of spatial-domain resources and the index associated with the first set of spatial-domain resources is one of a combinatorial-based index or a bitmap-based index, wherein the combinatorial-based index comprises at least a third number of bits capable of representing a fourth number equal to a number of possible combinations of the second number of spatial-domain resources in the first set of spatial-domain resources selected from the first number of spatial-domain resources in the plurality of spatial-domain resources, and wherein the bitmap-based index comprises a number of bits equal to the first number of spatial-domain resources in the plurality of spatial-domain resources and includes a fifth number of bits indicating spatial-domain resources in the first set of spatial-domain resources, wherein the fifth number of bits is equal to the second number of spatial-domain resources in the first set of spatial-domain resources.

7. The apparatus of claim 6, wherein the at least one processor is further configured to:
transmit, based on the first number of spatial-domain resources in the plurality of spatial-domain resources and the second number of spatial-domain resources in the first set of spatial-domain resources, a sixth indication that the index is one of the combinatorial-based index or the bitmap-based index instead of a set of identifiers for identifying spatial-domain resources in the first set of spatial-domain resources.

8. The apparatus of claim 4, wherein the at least one processor is further configured to:
transmit a third indication of a second number of spatial-domain resources in the first set of spatial-domain resources, wherein the first indication of the index associated with the first set of spatial-domain resources is based on the third indication.

9. The apparatus of claim 8, wherein the first indication, the third indication, and the channel state information indicative of the at least one characteristic of each of the spatial-domain resources in the first set of spatial-domain resources are comprised in a variable-sized report payload, wherein the third indication is comprised in a first, fixed-size part of the variable-sized report payload and the first indication is included in a second, variable-sized part of the variable-sized report payload, wherein a size of the second, variable-sized part of the variable-sized report payload is based on the first number of spatial-domain resources indicated in the second indication and the second number of spatial-domain resources indicated in the third indication.

10. The apparatus of claim 1, wherein the at least one characteristic is a measure of signal strength associated with each of the spatial-domain resources in the first set of spatial-domain resources, wherein the channel state information indicative of the at least one characteristic of each of the spatial-domain resources in the first set of spatial-domain resources comprises a fourth indication of a first spatial-domain resource having a highest measured signal strength and a fifth indication of the highest measured signal strength.

11. The apparatus of claim 10, wherein the channel state information indicative of the at least one characteristic of each of the spatial-domain resources in the first set of spatial-domain resources further comprises a set of indications of differences between the highest measured signal strength and a measured signal strength for a corresponding set of spatial-domain resources in the first set of spatial-domain resources that does not include the first spatial-domain resource, wherein the corresponding set of spatial-domain resources is ordered based on one of a known or configured ordering.

12. The apparatus of claim 11, wherein spatial-domain resources in the plurality of spatial-domain resources and in the first set of spatial-domain resources are beams for transmission from a transmitting device, and the known or configured ordering is based on identifiers of the beams in the plurality of spatial-domain resources.

13. The apparatus of claim 11, wherein spatial-domain resources in the plurality of spatial-domain resources and the first set of spatial-domain resources are beam-pairs, wherein each beam-pair comprises a first beam for transmission from a transmitting device and a corresponding second beam for reception at a receiving device, and the known or configured ordering is based on identifiers of the first beams for transmission from the transmitting device and identifiers of the second beams for reception at the receiving device.

14. The apparatus of claim 1, wherein the wireless device is one of a base station, a network entity, or a network node, wherein to transmit the first indication the at least one processor is configured to transmit the first indication via one of a medium access control (MAC) control element (MAC-CE) or downlink control information (DCI), the at least one processor further configured to:
transmit a fourth indication that the at least one characteristic is one of a reference signal received power (RSRP) or a signal to interference-and-noise ratio (SINR); and
transmit a fifth indication for a second wireless device to measure the at least one characteristic, where the channel state information is received from the second wireless device.

15. The apparatus of claim 14, wherein the channel state information comprises a set of measured or predicted values associated with one of the RSRP or the SINR for each of the spatial-domain resources in the first set of spatial-domain resources.

16. The apparatus of claim 14, further comprising a transceiver or an antenna coupled to the at least one processor, wherein the at least one processor is further configured to:
transmit, via a configuration setting associated with measuring the at least one characteristic, a seventh indication of a number of spatial-domain resources in the plurality of spatial-domain resources via the transceiver or the antenna.

17. The apparatus of claim 16, wherein the at least one processor is further configured to:
transmit an eighth indication of a second number of spatial-domain resources in the first set of spatial-domain resources, wherein the first indication of the index associated with the first set of spatial-domain resources is based on the fourth indication and the fifth indication.

18. An apparatus for wireless communication at a wireless device, comprising:
a memory; and
at least one processor coupled to the memory and, based at least in part on first information stored in the memory, the at least one processor is configured to:
receive a first indication of an index associated with a first set of spatial-domain resources in a plurality of spatial-domain resources; and
receive or transmit channel state information indicative of at least one of the index associated with the first set of spatial-domain resources or at least one characteristic of each spatial-domain resource in the first set of spatial-domain resources.

19. The apparatus of claim 18, wherein the apparatus is one of a base station, a network entity, or a network node, wherein the at least one processor is further configured to:
transmit a second indication of a first number of spatial-domain resources in the plurality of spatial-domain resources; and
transmit a third indication of a second number of spatial-domain resources in the first set of spatial-domain resources, wherein the index associated with the first set of spatial-domain resources is one of a combinatorial-based index or a bitmap-based index, wherein the combinatorial-based index comprises at least a third number of bits capable of representing a fourth number equal to a number of possible combinations of the second number of spatial-domain resources in the first set of spatial-domain resources selected from the first number of spatial-domain resources in the plurality of spatial-domain resources, and wherein the bitmap-based index comprises a number of bits equal to the first number of spatial-domain resources in the plurality of spatial-domain resources and includes a fifth number of bits indicating spatial-domain resources in the first set of spatial-domain resources, wherein the fifth number of bits is equal to the second number of spatial-domain resources in the first set of spatial-domain resources.

20-27. (canceled)

28. A method of wireless communication at a wireless device, comprising:
transmitting a first indication of an index associated with a first set of spatial-domain resources in a plurality of spatial-domain resources; and
transmitting or receiving channel state information indicative of at least one of the index associated with the first set of spatial-domain resources or at least one characteristic of each spatial-domain resource in the first set of spatial-domain resources.

29-30. (canceled)
